(19) United States
(12) Patent Application Publication
(10) Pub. No.: US 2025/0071693 A1
(43) Pub. Date: Feb. 27, 2025

(54) COMMUNICATION METHOD AND RELATED APPARATUS

(71) Applicant: Huawei Technologies Co., Ltd., Shenzhen (CN)

(72) Inventors: Ting Wang, Shanghai (CN); Yongxia Lyu, Shenzhen (CN); Hong Ren, Nanjing (CN); Qihao Peng, Nanjing (CN); Cunhua Pan, Nanjing (CN)

(21) Appl. No.: 18/941,901

(22) Filed: Nov. 8, 2024

Related U.S. Application Data
(63) Continuation of application No. PCT/CN2023/092117, filed on May 4, 2023.

(30) Foreign Application Priority Data
May 9, 2022 (CN) 202210497361.6

(51) Int. Cl. H04W 52/32; H04L 5/00

(52) U.S. Cl. CPC H04W 52/325; H04L 5/0048

(57) ABSTRACT

This application provides a communication method and a related apparatus. The method includes: A first communication device receives first indication information and second indication information from a second communication device. The first indication information indicates a power parameter, and the power parameter is related to transmit power of a pilot and transmit power of data. The second indication information indicates a pilot length and a data length, the pilot length is a time length for carrying the pilot, and the data length is a time length for carrying the data. The first communication device communicates with the second communication device based on the first indication information and the second indication information.

### CROSS-REFERENCE TO RELATED APPLICATIONS

This disclosure is a continuation of International Application No. PCT/CN2023/092117, filed on May 4, 2023, which claims priority to Chinese Patent Application No. 202210497361.6, filed on May 9, 2022. The disclosures of the aforementioned applications are hereby incorporated by reference in their entireties.

### TECHNICAL FIELD

This application relates to the field of communication technologies, and in particular, to a communication method and a related apparatus.

### BACKGROUND

Ultra-reliable low-latency communication (URLLC), as a typical scenario in three major application scenarios of a 5th generation mobile communication technology (5G), is very critical to wide application of fields such as autonomous driving, industrial manufacturing, an internet of vehicles, and a smart grid. URLLC has different requirements on latency, reliability, and bandwidth in different scenarios. To meet a requirement of each scenario for latency and reliability, related parameters of data and a pilot in a communication system need to be determined, to perform data transmission.

However, a current manner of configuring the related parameters of the pilot and the data is not flexible enough, and a requirement of a service, for example, a URLLC service, that has both a high latency requirement and a high reliability requirement may not be met.

### SUMMARY

This application provides a communication method and a related apparatus, so that a related parameter of a pilot and data can be flexibly and dynamically configured, to meet more service requirements.

According to a first aspect, a communication method is provided. The method may be applied to a first communication device, for example, may be performed by the first communication device, or may be performed by a component (such as a chip or a chip system) configured in the first communication device, or may be implemented by a logical module or software that can implement all or some functions of the first communication device. This is not limited in this application.

For example, the method includes: receiving first indication information, where the first indication information indicates a power parameter, and the power parameter is related to transmit power of a pilot and transmit power of data; receiving second indication information, where the second indication information indicates a pilot length and a data length, the pilot length is a time length for carrying the pilot, and the data length is a time length for carrying the data; and performing communication based on the first indication information and the second indication information.

Based on the foregoing solution, the first communication device may determine, based on the received first indication information, the power parameter related to the transmit power of the pilot and the transmit power of the data, and may determine the pilot length and the data length based on the received second indication information, to perform communication based on determined parameters. Because specific content of power parameter configuration is not limited, proper configuration may be made based on different scenarios, different service requirements, and the like. In addition, the data length and the pilot length may be flexibly configured based on different scenarios and different service requirements, so that the first communication device can determine a related parameter required for communication, to perform service transmission. According to the method, the related parameter that is of the pilot and the data and that is required for the service transmission in a communication system can be flexibly and dynamically indicated, and the parameter can be flexibly and dynamically adjusted based on a service requirement and an actual channel environment, thereby improving communication performance.

It should be understood that the pilot is also referred to as a reference signal or a training sequence, and the pilot is a known signal for both a transmit end device (the second communication device) and a receive end device (the first communication device). The transmit end device transmits a reference signal known to the receive end device, and the reference signal is received by the receive end device after being propagated through a channel. The receive end device compares the received reference signal with the known reference signal, to perform channel estimation. In this application, the transmit power of the pilot is for improving accuracy of the channel estimation, and the transmit power of the data is for improving accuracy of channel decoding.

With reference to the first aspect, in some implementations of the first aspect, the power parameter includes at least one of the following: the transmit power of the pilot, the transmit power of the data, a ratio of the transmit power of the pilot to the transmit power of the data, and a difference between the transmit power of the pilot and the transmit power of the data.

With reference to the first aspect, in some implementations of the first aspect, the power parameter includes: the transmit power of the pilot and the transmit power of the data, or the ratio of the transmit power of the pilot to the transmit power of the data.

It should be understood that, in downlink communication, the power parameter may be the ratio of the transmit power of the pilot to the transmit power of the data, or a ratio of the transmit power of the data to the transmit power of the pilot.

With reference to the first aspect, in some implementations of the first aspect, the first indication information is determined based on a capability of the first communication device, and the capability of the first communication device includes at least one of the following: a receiver capability, an algorithm capability, and a complexity processing capability.

It should be understood that, the receiver capability may include a simple receiver, a complex receiver, a basic receiver, an enhanced receiver, and the like. The algorithm capability may include a zero forcing (ZF) algorithm, a minimum mean square error (MMSE) algorithm, a maximum likelihood (ML) algorithm, a maximum ratio combining (MRC) algorithm, a local zero forcing algorithm, a full zero forcing (FZF) algorithm, and the like. The complexity processing capability may include a serial interference cancellation (SIC) capability, an interference cancellation processing capability, an iteration processing capability, and the like.

With reference to the first aspect, in some implementations of the first aspect, one or more of a value range of the transmit power of the pilot, a value range of the transmit power of the data, a value range of the ratio of the transmit power of the pilot to the transmit power of the data, and a value range of the difference between the transmit power of the pilot and the transmit power of the data have a correspondence with the capability of the first communication device, and are predefined or preconfigured.

It should be understood that the predefined value range may be a value range agreed on by a first network device and a second network device through a protocol. The preconfigured value range may be configured by the second communication device for the first communication device by using higher layer signaling (for example, radio resource control (RRC) signaling).

In the foregoing implementation, the communication device may configure a value of the power parameter based on the capability, and different capabilities may correspond to different value ranges. This reduces signaling indication overheads while meeting a communication requirement, improving communication performance.

With reference to the first aspect, in some implementations of the first aspect, the second indication information includes at least one of the following: a quantity of code division multiplexing (CDM) groups of the pilot, a quantity of first communication devices multiplexing a same resource, a subcarrier spacing of the pilot, a quantity of time units of the pilot, duration of the pilot, a subcarrier spacing of the data, a quantity of time units of the data, duration of the data, a ratio of the pilot length to the data length, and a total length of the pilot length and the data length. The quantity of CDM groups of the pilot has a correspondence with the pilot length, and the quantity of first communication devices multiplexing a same resource has a correspondence with the pilot length.

In the foregoing implementation, the communication device may configure the pilot length and the data length based on a quantity of users in multi-user multiplexing, and different scenarios may correspond to different values. This reduces pilot overheads while meeting a multi-user communication performance requirement, improving communication performance.

With reference to the first aspect, in some implementations of the first aspect, the second indication information includes the subcarrier spacing of the pilot, the quantity of time units of the pilot, the subcarrier spacing of the data, and the quantity of time units of the data.

With reference to the first aspect, in some implementations of the first aspect, the pilot length includes the subcarrier spacing of the pilot, the quantity of time units of the pilot, or duration of the pilot. The data length includes the subcarrier spacing of data, the quantity of time units of the data, or duration of the data.

In the foregoing implementation, the communication device may configure the pilot length and the data length by indicating the subcarrier spacing and the quantity of time units, and different scenarios may correspond to different values. This reduces indication overheads while meeting a multi-user communication performance requirement, implementing flexible transmission, and improving communication performance.

With reference to the first aspect, in some implementations of the first aspect, the correspondence between the quantity of code division multiplexing CDM groups of the pilot and the pilot length is determined based on a first mapping relationship, and the first mapping relationship indicates the correspondence between the quantity of CDM groups of the pilot and the pilot length. The correspondence between the quantity of first communication devices multiplexing a same resource and the pilot length is determined based on a second mapping relationship, and the second mapping relationship indicates the correspondence between the quantity of first communication devices multiplexing a same resource and the pilot length. The first mapping relationship and/or the second mapping relationship are/is predefined or preconfigured.

In the foregoing implementation, the communication device may configure the pilot length and the data length based on the mapping relationship, and different scenarios may correspond to different values. This reduces indication overheads while meeting a multi-user communication performance requirement, improving communication performance.

With reference to the first aspect, in some implementations of the first aspect, the method further includes: determining, based on channel measurement on M access points, channel states corresponding to the M access points; and determining, based on a threshold and the channel states, a quantity Mₖ of target access points fed back by the first communication device and channel state information corresponding to the target access points, where a sum of the channel state information of the Mₖ target access points and a sum of channel state information of the M access points are greater than or equal to the threshold, and M and Mₖ are positive integers.

In the foregoing implementation, the communication device may determine a quantity of access points based on the threshold, and feed back the channel state information, and different scenarios may correspond to different values. This reduces feedback overheads while meeting a multi-transmission point communication performance requirement, improving communication performance.

With reference to the first aspect, in some implementations of the first aspect, the method further includes: sending the channel state information corresponding to the Mₖ target access points; and/or sending a recommended threshold.

With reference to the first aspect, in some implementations of the first aspect, the threshold is predefined, or the threshold is carried in the higher layer signaling and/or physical layer signaling.

With reference to the first aspect, in some implementations of the first aspect, the threshold has a correspondence with a first parameter, and the first parameter includes at least one of the following: a scenario, the quantity of access points, and the capability of the first communication device.

In the foregoing implementation, a value of the threshold may be determined based on the scenario, the quantity of access points, the capability, and the like, that is, different cases may correspond to different values. This reduces signaling overheads while meeting a multi-transmission point communication performance requirement, improving communication performance.

According to a second aspect, another communication method is provided. The method may be applied to a second communication device, for example, may be performed by the second communication device, or may be performed by a component (such as a chip or a chip system) configured in the second communication device, or may be implemented by a logical module or software that can implement all or some functions of the second communication device. This is not limited in this application.

For example, the method includes: sending first indication information, where the first indication information indicates a power parameter, and the power parameter is related to transmit power of a pilot and transmit power of data; sending second indication information, where the second indication information indicates a pilot length and a data length, the pilot length is a time length for carrying the pilot, and the data length is a time length for carrying the data; and performing communication based on the first indication information and the second indication information.

Based on the foregoing solution, the second communication device may perform communication based on the determined power parameter related to the transmit power of the pilot and the transmit power of the data, and the determined pilot length and the determined data length. Because specific content of power parameter configuration is not limited, proper configuration may be made based on different scenarios, different service requirements, and the like. In addition, the data length and the pilot length may be flexibly configured based on different scenarios and different service requirements, so that the second communication device can determine a related parameter required for communication, to perform service transmission. According to the method, the related parameter that is of the pilot and the data and that is required for the service transmission in a communication system can be flexibly and dynamically indicated, and the parameter can be flexibly and dynamically adjusted based on a service requirement and an actual channel environment, thereby improving communication performance.

With reference to the second aspect, in some implementations of the second aspect, the power parameter includes at least one of the following: the transmit power of the pilot, the transmit power of the data, a ratio of the transmit power of the pilot to the transmit power of the data, and a difference between the transmit power of the pilot and the transmit power of the data.

With reference to the second aspect, in some implementations of the second aspect, the power parameter includes: the transmit power of the pilot and the transmit power of the data, or the ratio of the transmit power of the pilot to the transmit power.

With reference to the second aspect, in some implementations of the second aspect, the first indication information is determined based on a capability of the first communication device, and the capability of the first communication device includes at least one of the following: a receiver capability, an algorithm capability, and a complexity processing capability.

With reference to the second aspect, in some implementations of the second aspect, one or more of a value range of the transmit power of the pilot, a value range of the transmit power of the data, a value range of the ratio of the transmit power of the pilot to the transmit power of the data, and a value range of the difference between the transmit power of the pilot and the transmit power of the data have a correspondence with the capability of the first communication device, and are predefined or preconfigured.

In the foregoing implementation, the communication device may configure a value of the power parameter based on the capability, and different capabilities may correspond to different value ranges. This reduces signaling indication overheads while meeting a communication requirement, improving communication performance.

With reference to the second aspect, in some implementations of the second aspect, the second indication information includes at least one of the following:
a quantity of code division multiplexing CDM groups of the pilot, a quantity of first communication devices multiplexing a same resource, a subcarrier spacing of the pilot, a quantity of time units of the pilot, duration of the pilot, a subcarrier spacing of the data, a quantity of time units of the data, duration of the data, a ratio of the pilot length to the data length, and a total length of the pilot length and the data length. The quantity of CDM groups of the pilot has a correspondence with the pilot length, and the quantity of first communication devices multiplexing a same resource has a correspondence with the pilot length.

In the foregoing implementation, the communication device may configure the pilot length and the data length based on a quantity of users in multi-user multiplexing, and different scenarios may correspond to different values. This reduces pilot overheads while meeting a multi-user communication performance requirement, improving communication performance.

With reference to the second aspect, in some implementations of the second aspect, the second indication information includes the subcarrier spacing of the pilot, the quantity of time units of the pilot, the subcarrier spacing of the data, and the quantity of time units of the data.

With reference to the second aspect, in some implementations of the second aspect, the pilot length includes the subcarrier spacing of the pilot, the quantity of time units of the pilot, or duration of the pilot. The data length includes the subcarrier spacing of data, the quantity of time units of the data, or duration of the data.

In the foregoing implementation, the communication device may configure the pilot length and the data length by indicating the subcarrier spacing and the quantity of time units, and different scenarios may correspond to different values. This reduces indication overheads while meeting a multi-user communication performance requirement, implementing flexible transmission, and improving communication performance.

With reference to the second aspect, in some implementations of the second aspect, the correspondence between the quantity of code division multiplexing CDM groups of the pilot and the pilot length is determined based on a first mapping relationship, and the first mapping relationship indicates the correspondence between the quantity of CDM groups of the pilot and the pilot length. The correspondence between the quantity of first communication devices multiplexing a same resource and the pilot length is determined based on a second mapping relationship, and the second mapping relationship indicates the correspondence between the quantity of first communication devices multiplexing a same resource and the pilot length. The first mapping relationship and/or the second mapping relationship are/is predefined or preconfigured.

In the foregoing implementation, the communication device may configure the pilot length and the data length based on the mapping relationship, and different scenarios may correspond to different values. This reduces indication overheads while meeting a multi-user communication performance requirement, improving communication performance.

With reference to the second aspect, in some implementations of the second aspect, the method further includes: receiving channel state information corresponding to Mₖ target access points; and/or receiving a recommended threshold, where the channel state information corresponding to the Mₖ target access points is determined based on the threshold and channel states of M access points, the channel states of the M access points are determined based on channel measurement on the M access points, a sum of the channel state information of the Mₖ target access points and a sum of channel state information of the M access points are greater than or equal to the threshold, and M and Mₖ are positive integers.

In the foregoing implementation, the communication device may determine a quantity of access points based on the threshold, and feed back the channel state information, and different scenarios may correspond to different values. This reduces feedback overheads while meeting a multi-transmission point communication performance requirement, improving communication performance.

With reference to the second aspect, in some implementations of the second aspect, the threshold is predefined, or the threshold is carried in the higher layer signaling and/or physical layer signaling.

With reference to the second aspect, in some implementations of the second aspect, the threshold has a correspondence with a first parameter, and the first parameter includes at least one of the following: a scenario, the quantity of access points, and the capability of the first communication device.

In the foregoing implementation, a value of the threshold may be determined based on the scenario, the quantity of access points, the capability, and the like, that is, different cases may correspond to different values. This reduces signaling overheads while meeting a multi-transmission point communication performance requirement, improving communication performance.

According to a third aspect, a communication apparatus is provided, and is configured to perform the method according to any possible implementation of the first aspect. Specifically, the apparatus includes a module configured to perform the method according to any possible implementation of the first aspect.

In a design, the communication apparatus may include modules that are in one-to-one correspondence with the method/operation/step/action described in the first aspect. The modules may be implemented by a hardware circuit, software, or a combination of the hardware circuit and the software.

In another design, the communication apparatus is a communication chip. The communication chip may include an input circuit or interface configured to send information or data, and an output circuit or interface configured to receive information or data.

In another design, the communication apparatus is a first communication device. The first communication device may include a transmitting machine configured to send information or data, and a receiving machine configured to receive information or data.

In another design, the communication apparatus is configured to perform the method in any possible implementation of the first aspect. The communication apparatus may be configured in a terminal or a network device, or the communication apparatus is the terminal or the network device.

According to a fourth aspect, another communication apparatus is provided, and is configured to perform the method according to any possible implementation of the second aspect. Specifically, the communication apparatus includes a module configured to perform the method according to any possible implementation of the second aspect.

In a design, the communication apparatus may include modules that are in one-to-one correspondence with the method/operation/step/action described in the second aspect. The modules may be implemented by a hardware circuit, software, or a combination of the hardware circuit and the software.

In another design, the communication apparatus is a communication chip. The communication chip may include an input circuit or interface configured to send information or data, and an output circuit or interface configured to receive information or data.

In another design, the communication apparatus is a second communication device. The second communication device may include a transmitting machine configured to send information or data, and a receiving machine configured to receive information or data.

In another design, the communication apparatus is configured to perform the method in any possible implementation of the second aspect. The communication apparatus may be configured in a terminal or a network device, or the communication apparatus is a terminal or a network device.

According to a fifth aspect, another communication apparatus is provided, including a processor and a memory. The memory is configured to store a computer program. The processor is configured to invoke the computer program from the memory and run the computer program, so that the communication apparatus performs the method according to any possible implementation of any one of the foregoing aspects.

Optionally, there are one or more processors, and there are one or more memories.

Optionally, the memory may be integrated with the processor, or the memory and the processor are separately disposed.

Optionally, the communication device further includes a transmitting machine (transmitter) and a receiving machine (receiver). The transmitting machine and the receiving machine may be disposed separately, or may be integrated together to be referred to as a transceiver machine (transceiver).

According to a sixth aspect, a communication system is provided, including a communication apparatus configured to implement the method according to any one of the first aspect or the possible implementations of the first aspect, or including a communication apparatus configured to implement the method according to the second aspect or any one of the possible implementations of the second aspect.

In a possible design, the communication system may further include a device that interacts with the first communication device and/or the second communication device in the solutions provided in embodiments of this application.

According to a seventh aspect, a computer program product is provided. The computer program product includes a computer program (which may also be referred to as code or instructions). When the computer program is run, a computer performs the method according to any possible implementation of any one of the foregoing aspects.

According to an eighth aspect, a computer-readable storage medium is provided. The computer-readable storage medium stores a computer program (which may also be referred to as code or instructions). When the computer program is run on a computer, the computer performs the method according to any possible implementation of any one of the foregoing aspects.

### BRIEF DESCRIPTION OF THE DRAWINGS

FIG. 1 is a diagram of a communication scenario according to an embodiment of this application;

FIG. 2 is a schematic flowchart of a communication method according to an embodiment of this application;

FIG. 3 is a schematic flowchart of another communication method according to an embodiment of this application;

FIG. 4 is a schematic flowchart of still another communication method according to an embodiment of this application;

FIG. 5 is a schematic flowchart of a measurement and feedback method according to an embodiment of this application;

FIG. 6a to FIG. 6d are diagrams in which weighted sum rates vary with an access point threshold in different factory building areas according to embodiments of this application;

FIG. 7a to FIG. 7d are diagrams in which weighted sum rates vary with energy in different factory building areas according to embodiments of this application;

FIG. 8a to FIG. 8d are diagrams in which weighted sum rates vary with bandwidth in different factory building areas according to embodiments of this application;

FIG. 9 is a diagram in which weighted sum rates vary with energy in three different solutions according to an embodiment of this application;

FIG. 10 is a block diagram of a communication apparatus according to an embodiment of this application; and

FIG. 11 is a block diagram of another communication apparatus according to an embodiment of this application.

### DETAILED DESCRIPTION OF ILLUSTRATIVE EMBODIMENTS

The following describes the technical solutions of this application with reference to the accompanying drawings.

The technical solutions provided in this application may be applied to various communication systems, for example, a long term evolution (LTE) system, an LTE frequency division duplex (FDD) system, an LTE time division duplex (TDD) system, a universal mobile telecommunications system (UMTS), a 5G mobile communication system, a new radio (NR) system or another evolved communication system, a next generation mobile communication system of a 5G communication system, a 6th generation (6G) communication system, or a future communication system.

The technical solutions provided in this application may be further applied to machine type communication (MTC), long term evolution-machine (LTE-M), a device-to-device (D2D) network, a machine-to-machine (M2M) network, an internet of things (IoT) network, or another network. The IoT network may include, for example, an internet of vehicles. Communication manners in an internet of vehicles system are collectively referred to as vehicle-to-X (vehicle-to-X, V2X, where X may represent everything). For example, the V2X may include: vehicle-to-vehicle (V2V) communication, vehicle-to-infrastructure (V2I) communication, vehicle-to-pedestrian (V2P) communication, or vehicle-to-network (V2N) communication.

The technical solutions provided in this application may be further applied to a non-terrestrial communication network (NTN) communication system such as a satellite communication system. The NTN communication system may be integrated with a wireless communication system.

The technical solutions in embodiments of this application may be further applied to an inter-satellite communication system, a wireless projection system, a virtual reality (VR) communication system, an integrated access and backhaul (IAB) system, a wireless fidelity (Wi-Fi) communication system, an optical communication system, or the like.

The technical solutions provided in this application may be further applied to a device-to-device (D2D) communication system, a vehicle-to-everything (V2X) communication system, a machine-to-machine (M2M) communication system, an MTC system, an internet of things (IoT) communication system, an integrated sensing and communication system, or another communication system.

An applied communication system and a network architecture of the communication system are not specifically limited in the technical solutions in embodiments of this application.

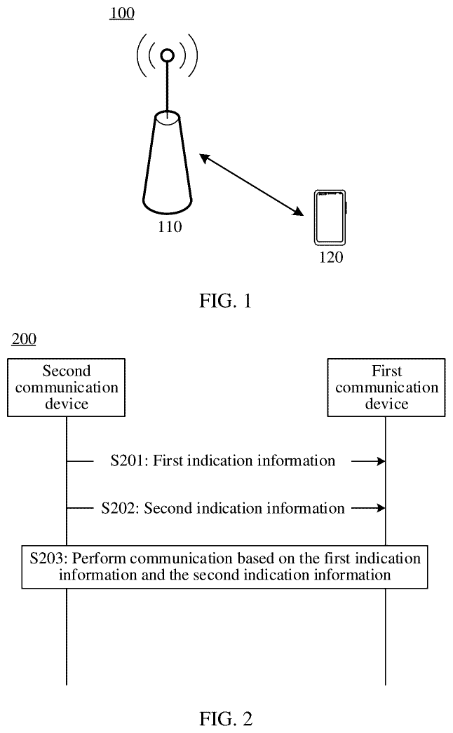

For ease of understanding of embodiments of this application, a communication system applicable to embodiments of this application is first described in detail with reference to FIG. 1.

FIG. 1 is a diagram of a communication scenario applicable to an embodiment of this application. As shown in FIG. 1, the communication system 100 includes at least two communication devices, for example, a network device 110 and at least one terminal 120. Data communication may be performed between the network device 110 and the at least one terminal 120 through a wireless connection. Specifically, the network device 110 may send downlink data to the terminal 120, and the terminal 120 may also send uplink data to the network device 110.

In embodiments of this application, a terminal (for example, the terminal 120 shown in FIG. 1) is a device having a wireless transceiver function, and may also be referred to as user equipment (UE), a mobile station (MS), a mobile terminal (MT), an access terminal, a subscriber unit, a subscriber station, a mobile station, a remote station, a remote terminal, a mobile device, a user terminal, a terminal, a wireless communication device, a user agent, a user apparatus, or the like.

The terminal may be a device providing a user with voice and/or data connectivity, for example, a handheld device or a vehicle-mounted device having a wireless connection function. Currently, some examples of the terminal are a mobile phone, a tablet computer, a notebook computer, a palmtop computer, a mobile internet device (MID), a wearable device, a VR device, an augmented reality (AR) device, a wireless terminal in industrial control, a wireless terminal in self-driving, a wireless terminal in remote surgery, a wireless terminal in a smart grid, a wireless terminal in transportation safety, a wireless terminal in a smart city, a wireless terminal in a smart home, a sensor terminal, a sensing terminal, an integrated sensing and communication device, a cellular phone, a cordless phone, a session initiation protocol (SIP) phone, a wireless local loop (WLL) station, a personal digital assistant (PDA), a handheld device having a wireless communication function, a computing device or another processing device connected to a wireless modem, a vehicle-mounted device, a wearable device, a terminal in a 5G network, or a terminal in a future evolved public land mobile communication network (PLMN). A specific technology, a device form, and a name used by the terminal are not limited in embodiments of this application.

By way of example but not limitation, in this application, the terminal may be a terminal in an internet of things (IoT) system. The internet of things is an important part in future development of information technologies. A main technical feature of the internet of things is to connect things to a network by using a communication technology, to implement an intelligent network for human-machine interconnection and thing-thing interconnection. For example, in embodiments of this application, the terminal may be a wearable device. The wearable device may also be referred to as a wearable intelligent device, and is a general term of a wearable device that is intelligently designed and developed for daily wear by using a wearable technology, for example, glasses, gloves, a watch, clothing, and shoes. The wearable device is a portable device that can be directly worn on a body or integrated into clothes or an accessory of a user. The wearable device is not only a hardware device, but can also implement a powerful function through software support, data exchange, and cloud interaction. Generalized wearable intelligent devices include full-featured and large-size devices that can implement complete or partial functions without depending on smartphones, such as smart watches or smart glasses, and devices that dedicated to only one type of application function and need to be used together with other devices such as smartphones, such as various smart bands or smart jewelry for monitoring physical signs.

In this application, a network device may be a device (for example, the network device 110 shown in FIG. 1) configured to communicate with the terminal, or may be a device that enables the terminal to access a wireless network. The network device may be a node in a radio access network. The network device may be a base station, an evolved NodeB (eNodeB), a transmission reception point (TRP), a home base station (for example, a home evolved NodeB or a home NodeB, HNB), a Wi-Fi access point (AP), a mobile switching center, a next generation base station (gNB) in a 5G mobile communication system, a next generation base station in a 6G mobile communication system, a base station in a future mobile communication system, or the like. Alternatively, the network device may be a module or a unit that implements a part of functions of the base station, for example, may be a central unit (CU), a distributed unit (DU), a remote radio unit (RRU), or a baseband unit (BBU). Alternatively, the network device may be a device providing a base station function in a D2D communication system, a V2X communication system, an M2M communication system, an IoT communication system, and the like. Alternatively, the network device may be a network device in an NTN, in other words, the network device may be deployed on a high altitude platform or a satellite. The network device may be a macro base station, may be a micro base station or an indoor base station, may be a relay node or a donor node, or the like. Certainly, the network device may alternatively be a node in a core network. A specific technology, a device form, and a name used by the network device are not limited in embodiments of this application.

In embodiments of this application, a function of the network device may alternatively be performed by a module (for example, a chip) in the network device, or may be performed by a control subsystem including the function of the network device. The control subsystem including the function of the network device herein may be a control center in the foregoing terminal application scenarios such as a smart grid, industrial control, intelligent transportation, a smart city, and an integrated sensing and communication system. A terminal function may be performed by a module (for example, a chip or a modem) in the terminal, or may be performed by an apparatus including the terminal function.

It should be noted that roles of the network device and the terminal may be relative. For example, a network device #1 may be configured as a mobile base station. For terminals that access a network through the network device #1, the network device #1 is a base station. However, for a network device #2 that communicates with the network device #1 through a wireless air interface protocol, the network device #1 is a terminal. Certainly, the network device #1 and the network device #2 may also communicate with each other through an interface protocol between base stations. In this case, the network device #1 is also a base station relative to the network device #2.

In embodiments of this application, both the network device and the terminal may be collectively referred to as a communication device or a communication apparatus. For example, the base station may be referred to as a communication device having a base station function, and the terminal may be referred to as a communication device having a terminal function. The network device and the terminal in this application may be deployed on land, including being deployed indoor, outdoor, handheld, wearable, or vehicle-mounted; or may be deployed on a water surface (for example, on a ship); or may be deployed in the air (for example, on an airplane, a balloon, or a satellite). Application scenarios of the network device and the terminal are not limited in this application.

In embodiments of this application, communication between the network device and the terminal, communication between network devices, and communication between terminals may be performed by using a licensed spectrum, or may be performed by using an unlicensed spectrum, or may be performed by using both a licensed spectrum and an unlicensed spectrum. The technical solutions of this application are applicable to a low frequency scenario, for example, sub 6G (which is a frequency band below 6 GHZ, and may specifically be 6 gigahertz (gigahertz, GHz) (which may be referred to as 6G for short) with a working frequency from 450 megahertz (MHz) to 6000 MHz), and are also applicable to a high frequency scenario (for example, above 6 GHz, for example, 28 GHz or 70 GHz), terahertz (THz), optical communication, and the like. For example, the network device and the terminal may communicate with each other by using a spectrum below 6 GHZ, may communicate with each other by using a spectrum above 6 GHz, or may communicate with each other by using both a spectrum below 6 GHz and a spectrum above 6 GHz. A spectrum resource used for communication is not limited in embodiments of this application.

In this application, the function of the network device may alternatively be performed by a module (for example, a chip) in the network device, or may be performed by a control subsystem including the function of the network device. The control subsystem including the function of the network device herein may be a control center in the foregoing terminal application scenarios such as a smart grid, industrial control, intelligent transportation, and a smart city. A terminal function may be performed by a module (for example, a chip or a modem) in the terminal, or may be performed by an apparatus including the terminal function.

The technical solutions provided in this application may be further applied to various types of communication links, for example, a user to network universal (Uu) link, a satellite link, a sidelink (SL), and a relay link. This is not limited in this application.

It should be understood that FIG. 1 is merely a simplified diagram for ease of understanding. The communication system 100 may further include another device that is not shown in FIG. 1.

As one of the three typical 5G services, URLLC is mainly applied to scenarios such as autonomous driving, industrial manufacturing, an internet of vehicles, and a smart grid. These application scenarios impose stricter requirements on reliability and latency.

For example, in the industrial manufacturing scenario, a manufacturing device in a smart factory accesses an enterprise cloud or an onsite control system through 5G, collects onsite environment data and production data, and analyzes a production status in real time, to implement unmanned and wireless automation of an entire production line. Intelligent industrial manufacturing has a high requirement on technical performance, and the high-end manufacturing industry has a very high requirement on latency and stability of a workshop device. Specifically, the industry for the smart factory proposes a very specific performance requirement. For example, there are no more than 50 users in a service area, and in end-to-end latency of 1 ms, communication service availability (CSA) of a data packet with a size of 40 bytes needs to be between 99.9999% and 99.999999%. The CSA is defined as follows: If a packet received by a receive end is damaged or is not received in time (where allowed maximum end-to-end latency is exceeded), the service is considered to be unavailable.

To meet a requirement of each scenario for latency and reliability, a related parameter of a pilot and data in a communication system needs to be determined, to perform data transmission.

In some embodiments, for Uu communication, power of an existing physical downlink shared channel (PDSCH) is calculated as follows:

When demodulation is performed based on a cell reference signal (CRS) in a transmission mode (TM) 1 to a TM 7:

For a symbol without a CRS: PDSCH energy per resource element (EPRE)/CRS EPRE=ρ_{A}.

For a symbol with a CRS: PDSCH EPRE/CRS EPRE=ρ_{B}.

When demodulation is performed based on a demodulation reference signal (DMRS) in a transmission mode TM 8 to a TM 10:

For a symbol with a DMRS: PDSCH EPRE/DMRS EPRE=0 dB or −3 decibels (dB).

For a symbol with a CRS: PDSCH EPRE/CRS EPRE=ρ_{B}.

For a symbol with neither a CRS nor a DMRS: PDSCH EPRE/CRS EPRE=ρ_{A}.

Reference signal power is configured by using higher layer signaling, to determine ρ_{A} and ρ_{B}, so that PDSCH power on each symbol can be determined.

In some embodiments, the DMRS includes two configuration types: a configuration 1 corresponding to two CDM groups, and a configuration 2 corresponding to three CDM groups. A power ratio of the data to the pilot is determined based on the DMRS configuration type and a quantity of DMRS CDM groups without data mapping.

For example, in the configuration 1, when the quantity of DMRS CDM groups without data mapping is 1, the power ratio is 0 dB. In the configuration 2, when the quantity of DMRS CDM groups without data mapping is 3, the power ratio is-4.77 dB.

For a power ratio of a phase tracking reference signal (phase tracking reference signal, PTRS) to the PDSCH, a power ratio of the PTRS to the data is determined based on a power parameter configured by using the higher layer signaling and a quantity of PDSCH layers associated with the PTRS. For example, when the power parameter configured by using a higher layer is 0, and the quantity of PDSCH layers is 2, the power ratio is 3 dB. When the power parameter configured by using a higher layer is 1, and the quantity of PDSCH layers is 2, the power ratio is 0 dB.

In conclusion, a manner of determining transmit power of the pilot and transmit power of the data based on the power parameter configured by using the higher layer signaling is not flexible enough.

In view of this, an embodiment of this application provides a communication method. A first network device receives first indication information indicating a power parameter and second indication information indicating a pilot length and a data length, to perform communication based on the received first indication information and second indication information. In this manner, the power parameter, the data length, and the pilot length are flexibly indicated by the first indication information and the second indication information, so that a communication device that receives the indication information can flexibly determine a related parameter required for communication, to perform service transmission. According to the method, the related parameter required for the service transmission in a communication system can be flexibly indicated, thereby improving communication performance.

Before the method provided in this application is described, the following several points are first described.

First, in this application, “indication” may include a direct indication and an indirect indication, or may include an explicit indication and an implicit indication. Information indicated by specific information is referred to as to-be-indicated information. In a specific implementation process, the to-be-indicated information may be indicated in many manners. By way of example but not limitation, the to-be-indicated information may be directly indicated. For example, the to-be-indicated information or an index of the to-be-indicated information is indicated. Alternatively, the to-be-indicated information may be indirectly indicated by indicating other information, and there is an association relationship between the other information and the to-be-indicated information. Alternatively, only a part of the to-be-indicated information may be indicated, and the other part of the to-be-indicated information is known or pre-agreed on. For example, specific information may alternatively be indicated by using an arrangement sequence of a plurality of pieces of information that is pre-agreed on (for example, stipulated in a protocol), to reduce indication overheads to some extent.

Second, in embodiments shown in this specification, terms and English abbreviations, for example, a pilot, pilot power, and a pilot length, are all examples provided for ease of description, and should not be construed as any limitation on this application. This application does not exclude a possibility of defining another term that can implement a same or similar function in an existing or future protocol.

Third, “first”, “second”, and various numbers in the following embodiments are merely used for differentiation for ease of description, but are not intended to limit the scope of embodiments of this application. For example, different information and different parameters are distinguished.

Fourth, in the following embodiments, “predefined” may be implemented by pre-storing corresponding code or a corresponding table in a device (for example, including a terminal device and a network device), or may be implemented in another manner that may indicate related information. A specific implementation of “predefined” is not limited in this application.

Fifth, “protocols” in embodiments of this application may refer to standard protocols in the communication field, for example, may include an LTE protocol, an NR protocol, and a related protocol applied to a future communication system. This is not limited in this application.

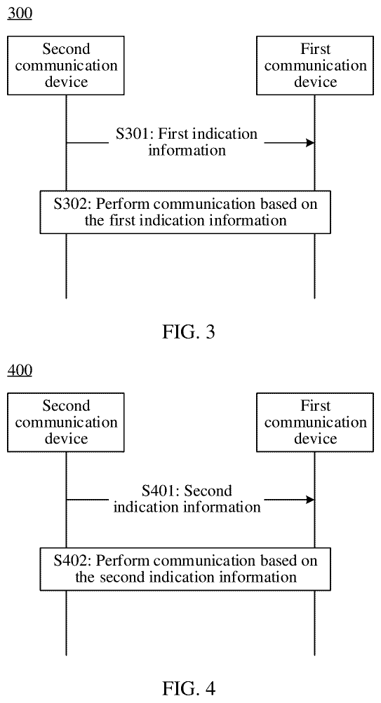

The following describes in detail a communication method 200 according to an embodiment of this application with reference to FIG. 2. The method 200 may be applied to the communication system 100 shown in FIG. 1. However, this embodiment of this application is not limited thereto. In FIG. 2, an example in which a first communication device and a second communication device are execution bodies of interaction illustration is for illustrating the method 200. However, the execution bodies of the interaction illustration are not limited in this application. For example, the first communication device in FIG. 2 may alternatively be a chip, a chip system, or a processor that supports the communication device in implementing the method, or may be a logical module or software that can implement all or some functions of the first communication device. The second communication device in FIG. 2 may alternatively be a chip, a chip system, or a processor that supports the communication device in implementing the method, or may be a logical module or software that can implement all or some functions of the second communication device.

It should be understood that the first communication device in FIG. 2 may be a terminal or a network device, and the second communication device may also be the terminal or the network device. For example, interaction shown in FIG. 2 may be interaction between a terminal (the first communication device) and a network device (the second communication device), interaction between a terminal (the first communication device) and a terminal (the second communication device), or interaction between a network device (the first communication device) and a network device (the second communication device).

FIG. 2 is a schematic flowchart of a communication method 200 according to an embodiment of this application. The method 200 may include S201 to S203. The following describes in detail each step in the method 200.

S201: A second communication device sends first indication information to a first communication device, and correspondingly, the first communication device receives the first indication information.

The first indication information indicates a power parameter, and the power parameter is related to transmit power of a pilot and transmit power of data, a quantity of slots, a quantity of sub-slots, a quantity of subframes, and the like.

It should be understood that the pilot is also referred to as a reference signal or a training sequence, and the pilot is a known signal for both a transmit end device (the second communication device) and a receive end device (the first communication device). The transmit end device transmits a reference signal known to the receive end device, and the reference signal is received by the receive end device after being propagated through a channel. The receive end device compares the received reference signal with the known reference signal, to perform channel estimation. In this embodiment of this application, the transmit power of the pilot is for improving accuracy of the channel estimation, and the transmit power of the data is for improving accuracy of channel decoding.

The reference signal may include but is not limited to a sounding reference signal (SRS), a channel state information reference signal (CSI-RS), a sensing reference signal, another reference signal, and the like.

S202: The second communication device sends second indication information to the first communication device, and correspondingly, the first communication device receives the second indication information.

The second indication information indicates a pilot length and a data length, the pilot length is a time length for carrying the pilot, and the data length is a time length for carrying the data.

It should be understood that the time length may be an absolute time length in a unit of a microsecond, a nanosecond, or a millisecond, or may be a quantity of symbols.

It should be further understood that the first indication information and the first indication information may be carried in same physical layer signaling, for example, downlink control information (DCI) and receive control information (RxCI), or may be carried in different signaling.

In this embodiment of this application, the pilot may be a DMRS that is carried on a physical resource and that is transmitted through a physical channel together with the data.

S203: The first communication device communicates with the second communication device based on the first indication information and the second indication information.

For example, the first communication device receives or sends the data, or sends or receives the reference signal based on the first indication information and the second indication information. The second communication device sends or receives the data, or receives or sends the reference signal based on the first indication information and the second indication information.

In this embodiment of this application, the first communication device may determine, based on the first indication information sent by the second communication device, the power parameter related to the transmit power of the pilot and the transmit power of the data, and may determine the pilot length and the data length based on the received second indication information, to perform communication based on determined parameters. Because specific content of power parameter configuration is not limited, proper configuration may be made based on different scenarios, different service requirements, and the like. In addition, the data length and the pilot length may be flexibly configured based on different scenarios and different service requirements, so that the first communication device can determine a related parameter required for communication, to perform service transmission. According to the method, the related parameter that is of the pilot and the data and that is required for the service transmission in a communication system can be flexibly indicated, thereby improving communication performance.

In an optional embodiment, the power parameter includes at least one of the following: the transmit power of the pilot, the transmit power of the data, a ratio of the transmit power of the pilot to the transmit power of the data, and a difference between the transmit power of the pilot and the transmit power of the data.

Optionally, the first indication information includes: the transmit power of the pilot and/or the transmit power of the data; the transmit power of the pilot and the ratio of the transmit power of the pilot to the transmit power of the data; the transmit power of the data and the ratio of the transmit power of the pilot to the transmit power of the data; the transmit power of the pilot and the difference between the transmit power of the pilot and the transmit power of the data; the transmit power of the data and the difference between the transmit power of the pilot and the transmit power of the data; the ratio of the transmit power of the pilot to the transmit power of the data; or the difference between the transmit power of the pilot and the transmit power of the data.

It should be understood that the ratio may alternatively be a ratio of the transmit power of the data to the transmit power of the pilot, and the difference may alternatively be a difference between the transmit power of the data and the transmit power of the pilot. The ratio of the transmit power of the pilot to the transmit power of the data represents a value obtained by dividing the transmit power of the pilot by the transmit power of the data. The ratio of the transmit power of the data to the transmit power of the pilot represents a value obtained by dividing the transmit power of the data by the transmit power of the pilot. The difference between the transmit power of the pilot and the transmit power of the data represents a value obtained by subtracting the transmit power of the data from the transmit power of the pilot. The ratio of the transmit power of the data to the transmit power of the pilot represents a value obtained by subtracting the transmit power of the pilot from the transmit power of the data.

With reference to the content included in the first indication information, for example, when the first indication information indicates the transmit power of the pilot and the ratio of the transmit power of the pilot to the transmit power of the data, the first communication device may determine the transmit power of the data based on the ratio and the transmit power of the pilot. For example, the transmit power of the data is equal to the transmit power that is of the pilot and that is divided by the ratio.

It should be further understood that when the first indication information indicates only the transmit power of the pilot (or the power of the data), a manner of determining the transmit power of the data (or the transmit power of the pilot) may be predefined, or may be preconfigured. Alternatively, when the first indication information indicates only the ratio of the transmit power of the pilot to the transmit power of the data, the transmit power of the pilot or the transmit power of the data may be predefined or preconfigured.

In an optional embodiment, the first indication information is determined based on a capability of the first communication device, and the capability of the first communication device includes at least one of the following: a receiver capability, an algorithm capability, and a complexity processing capability.

For example, the receiver capability may include a simple receiver, a complex receiver, a basic receiver, an enhanced receiver, and the like. The algorithm capability may include a ZF algorithm, an MMSE algorithm, an ML algorithm, an MRC algorithm, a local zero forcing algorithm, an FZF algorithm, and the like. The complexity processing capability may include a SIC capability, an interference cancellation processing capability, an iteration processing capability, and the like.

For example, the first indication information is determined based on the MRC algorithm or the FZF algorithm capability. For example, for the FZF algorithm, the transmit power of the data is predefined, and the first indication information indicates only the ratio of the transmit power of the pilot to the transmit power of the data. For the MRC algorithm, the first indication information indicates the transmit power of the data and the transmit power of the pilot. It should be noted that, for the FZF algorithm, the transmit power of the data is relatively stable (for example, 0.1 watt (w)), and the first indication information may indicate only the ratio of the transmit power of the pilot to the transmit power of the data. For the MRC algorithm, the transmit power of the pilot is unstable, and the first indication information needs to indicate the transmit power of the pilot and the transmit power of the data or the ratio of the transmit power of the pilot to the transmit power of the data.

In an optional embodiment, one or more of a value range of the transmit power of the pilot, a value range of the transmit power of the data, a value range of the ratio of the transmit power of the pilot to the transmit power of the data, and a value range of the difference between the transmit power of the pilot and the transmit power of the data have a correspondence with the capability of the first communication device, and are predefined or preconfigured.

For example, one or more of the value range of the transmit power of the pilot, the value range of the transmit power of the data, the value range of the ratio of the transmit power of the pilot to the transmit power of the data, and the value range of the difference between the transmit power of the pilot and the transmit power of the data may be predefined or preconfigured based on the capability of the first communication device.

It should be understood that the predefined value range may be a value range agreed on by a first network device and a second network device through a protocol. The preconfigured value range may be configured by the second communication device for the first communication device by using higher layer signaling (for example, RRC signaling). The foregoing value ranges may be determined by the communication device based on the capability of the first communication device. For example, a power ratio range corresponding to the FZF algorithm may be 0 dB, 3 dB, 4.77 dB, 6 dB, 6.99 dB, 7.78 dB, 8.45 dB, 9 dB, 9.54 dB, and 10 dB. A power ratio range corresponding to the MRC algorithm may be 0 dB, 7.78 dB, 9 dB, and 10 dB.

It should be further understood that, in the foregoing embodiment, the transmit power of the pilot and/or the transmit power of the data that are/is indicated by the first indication information may be determined in a predefined or preconfigured power range. The ratio indicated by the first indication information may also be determined in a predefined or preconfigured ratio range. The difference indicated by the first indication information may also be determined in a predefined or preconfigured ratio range.

In an optional embodiment, the second indication information includes at least one of the following: a quantity of CDM groups of the pilot, a quantity of first communication devices multiplexing a same resource, a subcarrier spacing of the pilot, a quantity of time units of the pilot, duration of the pilot, a subcarrier spacing of the data, a quantity of time units of the data, duration of the data, a ratio of the pilot length to the data length, and a total length of the pilot length and the data length. The quantity of CDM groups of the pilot has a correspondence with the pilot length, and the quantity of first communication devices multiplexing a same resource has a correspondence with the pilot length.

It should be understood that the total length of the pilot length and the data length may alternatively be a difference between the pilot length and the data length.

It should be further understood that the pilot length and the data length may each be a quantity of time units (for example, a quantity of symbols), or may each be duration.

Optionally, the second indication information includes the subcarrier spacing of the pilot, the quantity of time units of the pilot, the subcarrier spacing of the data, and the quantity of time units of the data.

For example, when the pilot length and the data length each are the quantity of time units, the first indication information may include the subcarrier spacing and the quantity of symbols. For example, the subcarrier spacing of the pilot is 30 kHz, the quantity of symbols of the pilot is 1, the subcarrier spacing of the data is 15 kHz, and the quantity of symbols of the data is 2. The subcarrier spacing of the pilot is 30 kHz, the quantity of symbols of the pilot is 2, the subcarrier spacing of the data is 15 kHz, and the quantity of symbols of the data is 4. The subcarrier spacing of the pilot is 60 kHz, the quantity of symbols of the pilot is 1, the subcarrier spacing of the data is 30 kHz, and the quantity of symbols of the data is 2. The subcarrier spacing of the pilot is 60 kHz, the quantity of symbols of the pilot is 2, the subcarrier spacing of the data is 30 kHz, and the quantity of symbols of the data is 4. It should be noted that the subcarrier spacing of the pilot may be the same as or different from the subcarrier spacing of the data.

For example, when the pilot length and the data length each are the duration (which may also be referred to as absolute time), for example, the data length and the pilot length may each be 0.5 ms, 0.25 ms, or the like.

Optionally, the ratio of the pilot length to the data length may be a ratio of quantities of symbols. The ratio of the quantities of symbols may be a ratio of quantities of symbols corresponding to reference subcarrier spacings. The reference subcarrier spacing may be the subcarrier spacing of the data or the subcarrier spacing of the pilot, or may be a predefined reference subcarrier spacing or a configured reference subcarrier spacing. For example, in a corresponding reference subcarrier spacing, the data length or the pilot length may be four symbols, two symbols, or eight symbols, and the ratio may be 1, ½, ⅓, ¼, 2, 3, or 4.

Optionally, the ratio of the pilot length to the data length may be a ratio of the duration.

In an optional embodiment, the correspondence between the quantity of CDM groups of the pilot and the pilot length is determined based on a first mapping relationship, and the first mapping relationship indicates the correspondence between the quantity of CDM groups of the pilot and the pilot length. The correspondence between the quantity of first communication devices multiplexing a same resource and the pilot length is determined based on a second mapping relationship, and the second mapping relationship indicates the correspondence between the quantity of first communication devices multiplexing a same resource and the pilot length. The first mapping relationship and/or the second mapping relationship are/is predefined or preconfigured.

Table 1 shows a first mapping relationship. The foregoing first mapping relationship may be at least one row in Table 1.

TABLE 1

| Quantity of CDM | Pilot |
|---|---|
| groups of a pilot | length |
| 1 | P11 |
| 2 | P12 |
| 3 | P13 |

It can be learned from Table 1 that, in the first mapping relationship, a plurality of values of the quantity of CDM groups of the pilot and a plurality of pilot lengths are in one-to-one correspondence.

Table 2 shows a second mapping relationship. The foregoing second mapping relationship may be at least one row in Table 2.

TABLE 2

| Quantity of first | |
|---|---|
| communication | Pilot |
| devices | length |
| K1 | P21 |
| K2 | P22 |
| K3 | P23 |

It can be learned from Table 2 that, in the second mapping relationship, a plurality of values of the quantity of first communication devices multiplexing a same resource and a plurality of pilot lengths are in one-to-one correspondence. K1, K2, and K3 are positive integers.

It should be understood that the correspondence shown in Table 1 and/or the correspondence shown in Table 2 may be agreed on (predefined) in the protocol, or may be preconfigured by the second communication device.

It should be further understood that Table 1 and Table 2 may be combined into a third mapping relationship. The third mapping relationship includes a relationship between the plurality of values of the quantity of CDM groups of the pilot and the pilot length and a relationship between the plurality of values of the quantity of first communication devices multiplexing a same resource and the pilot length.

In this embodiment of this application, the first indication information indicates the quantity of CDM groups of the pilot (or the quantity of multiplexing first communication devices), and the first communication device that receives the first indication information may determine, from a preconfigured or predefined mapping relationship, the pilot length corresponding to the quantity of CDM groups of the pilot (or the quantity of multiplexing first communication devices) indicated by the first indication information.

In an optional embodiment, the method 200 further includes: determining, based on channel measurement on M access points, channel states corresponding to the M access points; and determining, based on a threshold and the channel states, a quantity Mₖ of target access points fed back by the first communication device and channel state information corresponding to the target access points, where a sum of the channel state information of the Mₖ target access points and a sum of channel state information of the M access points are greater than or equal to the threshold, and M and Mₖ are positive integers.

In this embodiment of this application, the communication device may measure and feed back the channel state information based on the threshold. In this process, a quantity of access points for providing a service for the first communication device may be determined, thereby improving communication performance.

It should be understood that, in this embodiment of this application, the channel state information may include large-scale information, and the determined channel state information that corresponds to the target access point fed back by the first communication device may be large-scale information corresponding to the target access point.

For example, Mₖ is determined in the following manner: Large-scale information corresponding to any k^{th} device is {_{m,k}}_{m=1, 2, . . . , M}, and the large-scale information is arranged in descending order and added to a set Mₖ one by one until

$$\frac{{\sum }_{m ∈ {M}_{k}} {β}_{m , k}}{{\sum }_{m = 1}^{M} {β}_{m , k}} \geq {T}_{h}$$

is true, where Tₕ is the threshold, a larger threshold indicates a larger quantity of access points, and k is an integer greater than 0 and less than or equal to M.

Optionally, the method 200 further includes: The first communication device sends the channel state information corresponding to the Mₖ target access points, and/or sends a recommended threshold. Correspondingly, the second communication device receives the channel state information corresponding to the Mₖ target access points, and/or receives the recommended threshold. Alternatively, the M access points simultaneously receive the channel state information corresponding to the Mₖ target access points, and/or receive the recommended threshold.

It should be understood that the determined target access point may include the second communication device.

It should be further understood that the recommended threshold may be a threshold determined by the first communication device based on the measured channel state information of the M access points, or may be predefined in the protocol or preconfigured.

In an optional embodiment, the threshold has a correspondence with a first parameter, and the first parameter includes at least one of the following: a scenario, a quantity of access points, and the capability of the first communication device.

Optionally, in this embodiment of this application, the threshold may alternatively be a threshold range.

For example, the foregoing scenario may include a factory building area and a bandwidth size. Table 3 shows a correspondence between a factory building area and a threshold, and a correspondence between a factory building area and a threshold range.

TABLE 3

| Scenario | Threshold range | Threshold |
|---|---|---|
| Factory building | a11 to a12 | a1 |
| area A1 | | |
| Factory building | a21 to a22 | a2 |
| area A2 | | |
| Factory building | a31 to a32 | a3 |
| area A3 | | |

It should be understood that the foregoing correspondence may alternatively be the correspondence between a factory building area and a threshold range, in other words, the correspondence includes a first column and a second column. Alternatively, the correspondence may be the correspondence between a factory building area and a threshold, in other words, the correspondence includes a first column and a third column.

Table 4 shows a correspondence between a quantity of access points and a threshold, and a correspondence between a quantity of access points and a threshold range. The correspondence may be at least one row in Table 5.

TABLE 4

| Total quantity | Threshold | |
|---|---|---|
| of access points | range | Threshold |
| M1 | b11 to b12 | b1 |
| M2 | b21 to b22 | b2 |
| M3 | b31 to b32 | b3 |

It should be understood that the foregoing correspondence may alternatively be the correspondence between a total quantity of access points and a threshold range, in other words, the correspondence includes a first column and a second column. Alternatively, the correspondence may be the correspondence between a total quantity of access points and a threshold, in other words, the correspondence includes a first column and a third column.

Table 5 shows a correspondence between a receiver algorithm and a threshold, and a correspondence between a receiver algorithm and a threshold range. The correspondence may be at least one row in Table 7.

TABLE 5

| Receiver algorithm | Threshold range | Threshold |
|---|---|---|
| Algorithm s1 | c11 to c12 | c1 |
| Algorithm s2 | c21 to c22 | c2 |
| Algorithm s3 | c31 to c32 | c3 |

It should be understood that the foregoing correspondence may alternatively be the correspondence between a receiver algorithm and a threshold range, in other words, the correspondence includes a first column and a second column. Alternatively, the correspondence may be the correspondence between a receiver algorithm and a threshold, in other words, the correspondence includes a first column and a third column.

It should be further understood that the correspondences shown in Table 3 to Table 5 may be predefined in the protocol, or may be preconfigured by the second communication device. For example, a value of the threshold may be any number between 0 and 1, for example, 0.1, 0.2, 0.5, 0.8, 0.9, or 1.

Further, for example, the correspondence between a factory building area and a threshold and the correspondence between a factory building area and a threshold range may be at least one row in Table 6.

TABLE 6

| Scenario (meter*meter) | Threshold range | Threshold |
|---|---|---|
| Factory building area 120*50 | 0.9 to 1 | 0.95 or 0.9 |
| Factory building area 240*100 | 0.8 to 0.9 | 0.85 or 0.8 |
| Factory building area 480*150 | 0.7 to 0.8 | 0.75 or 0.7 |

It should be understood that the foregoing correspondence may alternatively be the correspondence between a factory building area and a threshold range, in other words, the correspondence includes a first column and a second column. Alternatively, the correspondence may be the correspondence between a factory building area and a threshold, in other words, the correspondence includes a first column and a third column.

For example, the correspondence between a quantity of access points and a threshold and the correspondence between a quantity of access points and a threshold range may be at least one row in Table 7.

TABLE 7

| Total quantity | Threshold | |
|---|---|---|
| of access points | range | Threshold |
| 1 | 0.91 to 1 | 0.92 or 0.95 |
| 4 | 0.81 to 0.9 | 0.89 or 0.81 |
| 9 | 0.71 to 0.8 | 0.78 or 0.71 |

It should be understood that the foregoing correspondence may alternatively be the correspondence between a total quantity of access points and a threshold range, in other words, the correspondence includes a first column and a second column. Alternatively, the correspondence may be the correspondence between a total quantity of access points and a threshold, in other words, the correspondence includes a first column and a third column.

For example, the correspondence between a receiver algorithm and a threshold and the correspondence between a receiver algorithm and a threshold range may be at least one row in Table 8.

TABLE 8

| Receiver algorithm | Threshold range | Threshold |
|---|---|---|
| Algorithm MRC | 0.95 to 1 | 0.95 or 0.98 |
| Algorithm FZF | 0.9 to 0.95 | 0.91 or 0.93 |
| Algorithm SIC | 0.85 to 0.9 | 0.89 or 0.9 |

It should be understood that the foregoing correspondence may alternatively be the correspondence between a receiver algorithm and a threshold range, in other words, the correspondence includes a first column and a second column. Alternatively, the correspondence may be the correspondence between a receiver algorithm and a threshold, in other words, the correspondence includes a first column and a third column.

Optionally, in this embodiment of this application, the threshold may be carried in the higher layer signaling, or may be carried in physical layer signaling. For example, candidate values (that are predefined or preconfigured) of the threshold are 0.1, 0.2, 0.5, 0.8, 0.9, and 1. The physical layer signaling may indicate 0.1/0.2 by using one bit (0/1), and indicate 0.5/0.8/0.9/1 by using two bits (00/01/10/11).

It should be understood that quantities of access points for uplink communication and downlink communication may be different, and corresponding thresholds or threshold ranges may also be independently configured.

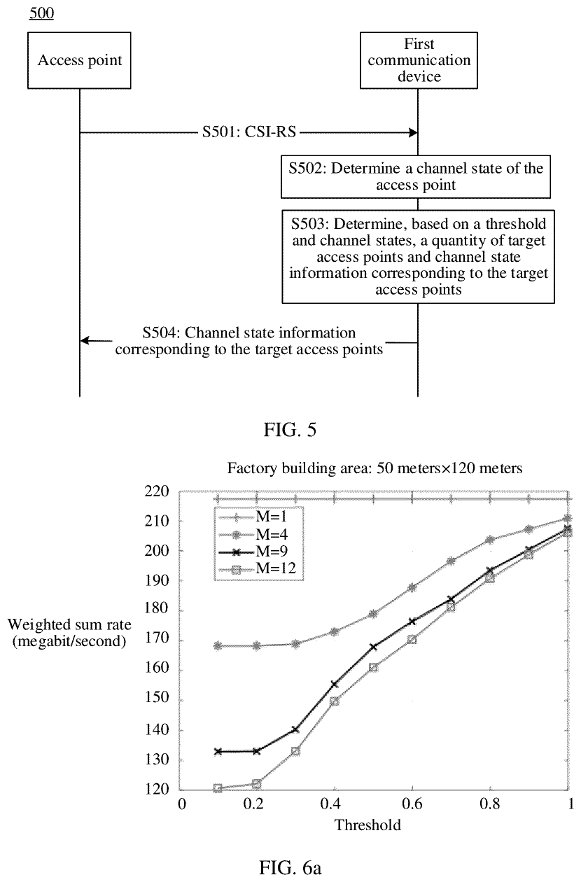

FIG. 3 is a schematic flowchart of another communication method 300 according to an embodiment of this application. The method 300 may be applied to the communication system 100 shown in FIG. 1. However, this embodiment of this application is not limited thereto. In FIG. 3, an example in which a first communication device and a second communication device are execution bodies of interaction illustration is for illustrating the method 300. However, the execution bodies of the interaction illustration are not limited in this application. For example, the first communication device in FIG. 3 may alternatively be a chip, a chip system, or a processor that supports the communication device in implementing the method, or may be a logical module or software that can implement all or some functions of the first communication device. The second communication device in FIG. 3 may alternatively be a chip, a chip system, or a processor that supports the communication device in implementing the method, or may be a logical module or software that can implement all or some functions of the second communication device.

As shown in FIG. 3, the method 300 includes S301 and S202. The following describes in detail each step in the method 300.

S301: The second communication device sends first indication information to the first communication device, and correspondingly, the first communication device receives the first indication information.

The first indication information indicates a power parameter, and the power parameter is related to transmit power of a pilot and transmit power of data.

Optionally, the power parameter includes at least one of the following: the transmit power of the pilot, the transmit power of the data, a ratio of the transmit power of the pilot to the transmit power of the data, and a difference between the transmit power of the pilot and the transmit power of the data.

It should be understood that the first indication information may be carried in physical layer signaling, for example, DCI or RxCI.

It should be further understood that, for content included in the first indication information, refer to the related descriptions of the first indication information in the method 200. Details are not described herein again.

In this embodiment of this application, the pilot is also referred to as a reference signal or a training sequence, and the pilot is a known signal for both a transmit end device (the second communication device) and a receive end device (the first communication device). The transmit end device transmits a reference signal known to the receive end device, and the reference signal is received by the receive end device after being propagated through a channel. The receive end device compares the received reference signal with the known reference signal, to perform channel estimation. In this embodiment of this application, the transmit power of the pilot is for improving accuracy of the channel estimation, and the transmit power of the data is for improving accuracy of channel decoding.

S302: The first communication device communicates with the second communication device based on the first indication information.

For example, the first communication device receives or sends the data, or sends or receives the reference signal based on the first indication information. The second communication device sends or receives the data, or receives or sends the reference signal based on the first indication information.

In this embodiment of this application, the pilot may be a DMRS that is carried on a physical resource and that is transmitted through a physical channel together with the data, and is a reference signal used for data demodulation.

In this embodiment of this application, a first network device receives, from the second communication device, the first indication information indicating the power parameter, to perform communication based on the received first indication information. In this manner, the power parameter is flexibly indicated by the first indication information, so that a communication device that receives the indication information can flexibly determine a related parameter required for communication, to perform service transmission. According to the method, the related parameter required for the service transmission in a communication system can be flexibly indicated, thereby improving communication performance.

Optionally, the first indication information indicates the transmit power of the data and the transmit power of the pilot. For example, a value range of a plurality of transmit power or a value range of a power ratio may be determined in a manner of configuration by using higher layer signaling or in a predefined manner, for example, 0.1 w, 0.2 w, 0.3 w, 0.4 w, . . . , 1 w, 7 w, 8 w, 9 w, and 10 w, or 15 decibel milliwatts (dBm) and 20 dBm. Further, the physical layer signaling dynamically indicates the transmit power of the pilot and the transmit power of the data, or the power ratio.

Optionally, the first indication information indicates the transmit power of the pilot and a difference between the transmit power of the data and the transmit power of the pilot. For example, for downlink, when the transmit power of the data is indicated, the transmit power of the pilot may be used as a baseline, and the difference is configured, in other words, the transmit power of the data is the transmit power of the pilot plus the difference between the transmit power of the data and the transmit power of the pilot. For example, a value range of a difference between a plurality of values of transmit power predefined in a protocol or configured by using a higher layer is: 0 dB, −3 dB, −4.77 dB, −6 dB, −6.99 dB, −7.78 dB, −8.45 dB, −9 dB, −9.54 dB, and −10 dB. Further, the physical layer signaling dynamically indicates the transmit power of the pilot, and the difference between the transmit power of the data and the transmit power of the pilot.

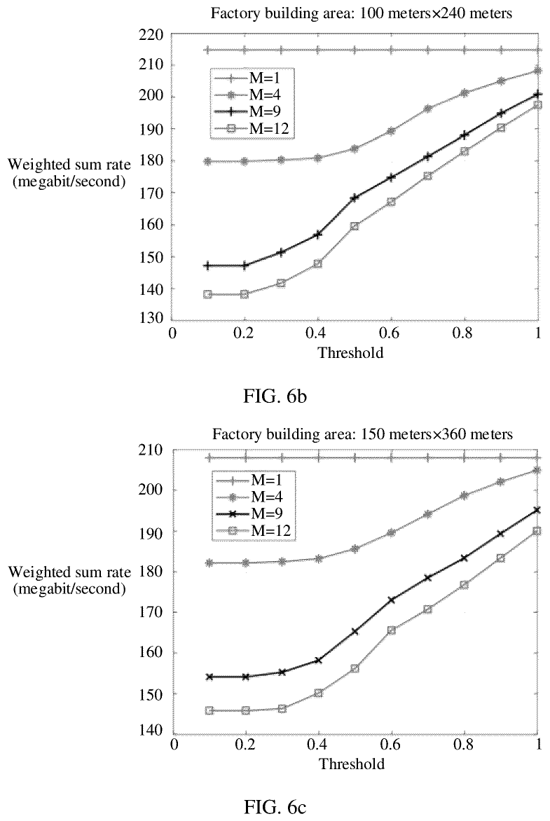

FIG. 4 is a schematic flowchart of still another communication method 400 according to an embodiment of this application. The method 400 may be applied to the communication system 100 shown in FIG. 1. However, this embodiment of this application is not limited thereto. In FIG. 4, an example in which a first communication device and a second communication device are execution bodies of interaction illustration is for illustrating the method 400. However, the execution bodies of the interaction illustration are not limited in this application. For example, the first communication device in FIG. 4 may alternatively be a chip, a chip system, or a processor that supports the communication device in implementing the method, or may be a logical module or software that can implement all or some functions of the first communication device. The second communication device in FIG. 4 may alternatively be a chip, a chip system, or a processor that supports the communication device in implementing the method, or may be a logical module or software that can implement all or some functions of the second communication device.

As shown in FIG. 4, the method 400 includes S401 and S402. The following describes in detail each step in the method 400.

S401: The second communication device sends second indication information to the first communication device, and correspondingly, the first communication device receives the second indication information.

The second indication information indicates a pilot length and a data length, the pilot length is a time length for carrying a pilot, and the data length is a time length for carrying data.

It should be understood that the time length may be an absolute time length in a unit of a microsecond, a nanosecond, or a millisecond, or may be a quantity of symbols, a quantity of slots, a quantity of sub-slots, a quantity of subframes, or the like.

It should be understood that the first indication information may be carried in DCI or RxCI.

In this embodiment of this application, the pilot may be a DMRS that is carried on a physical resource and that is transmitted through a physical channel together with the data, and is a reference signal used for data demodulation.

It should be further understood that, for content included in the second indication information, refer to the related descriptions of the second indication information in the method 200. Details are not described herein again.

In this embodiment of this application, the pilot length is for transmitting the pilot to improve accuracy of channel estimation, and the data length is for transmitting the data to improve accuracy of channel decoding.

S402: The first communication device communicates with the second communication device based on the second indication information.

For example, the first communication device receives or sends the data, or sends or receives the reference signal based on the second indication information. The second communication device sends or receives the data, or receives or sends the reference signal based on the second indication information.

In this embodiment of this application, a first network device receives, from the second communication device, the second indication information indicating the pilot length and the data length, to perform communication based on the received second indication information. In this manner, a power parameter, the data length, and the pilot length are flexibly indicated by the second indication information, so that a communication device that receives the indication information can flexibly determine a related parameter required for communication, to perform service transmission. According to the method, the related parameter required for the service transmission in a communication system can be flexibly indicated, thereby improving communication performance.

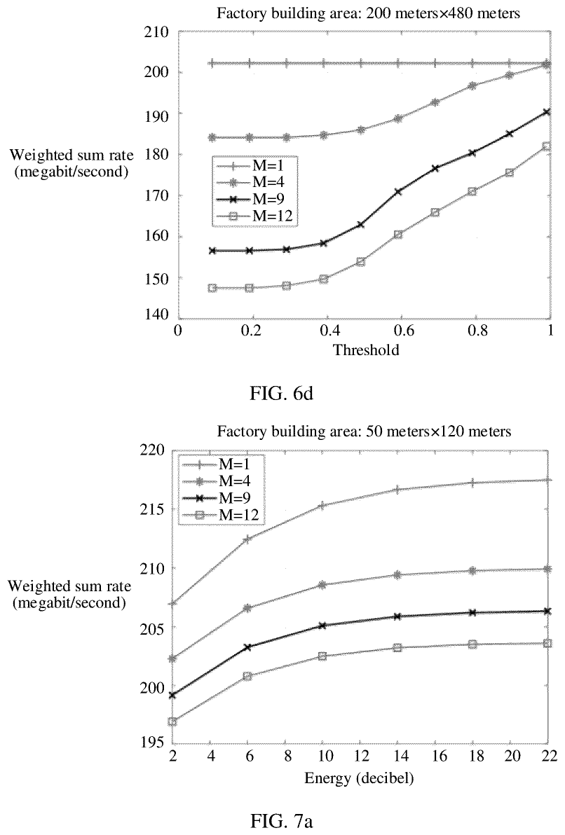

FIG. 5 is a schematic flowchart of a measurement and feedback method 500 according to an embodiment of this application. The method 500 may be applied to the communication system 100 shown in FIG. 1. However, this embodiment of this application is not limited thereto. In FIG. 5, an example in which an access point and a first communication device are execution bodies of interaction illustration is for illustrating the method 500. However, the execution bodies of the interaction illustration are not limited in this application. For example, the first communication device in FIG. 5 may alternatively be a chip, a chip system, or a processor that supports the communication device in implementing the method, or may be a logical module or software that can implement all or some functions of the first communication device. The access point in FIG. 5 may be the second communication device in the foregoing method or a chip, a chip system, or a processor that supports the communication device in implementing the method, or may be a logical module or software that can implement all or some functions of the access point.

As shown in FIG. 5, the method 500 includes S501 to S504. The following describes in detail each step in the method 500. It should be understood that there may be M access points shown in FIG. 5.

S501: The access point sends a channel state information reference signal (CSI-RS) to the first communication device, and correspondingly, the first communication device receives the CSI-RS.

It should be understood that the CSI-RS is for measuring a channel between the access point and the first communication device, and obtain channel state information, for example, a precoding matrix and channel quality information, required for scheduling and link adaptation.

It should be further understood that, in this embodiment of this application, the channel state information includes large-scale information.

S502: The first communication device determines a channel state of the access point.

When there are M access points, the first communication device determines channel states of the M access points based on channel measurement on the M access points.

S503: The first communication device determines, based on a threshold and the channel states, a quantity (denoted as Mₖ) of target access points fed back by the first communication device and channel state information corresponding to the target access points.

A sum of the channel state information of the Mₖ target access points and a sum of channel state information of the M access points are greater than or equal to the threshold, and Mₖ is a positive integer.

Optionally, the threshold may be sent by the access point to the first communication device, or may be predefined, or determined by a terminal device based on measured channel state information of a plurality of access points. It should be understood that the threshold has a correspondence with a first parameter, and the first parameter includes at least one of the following: a scenario, a quantity of access points, and a capability of the first communication device. For a specific correspondence, refer to the related descriptions in Table 3 to Table 8. Details are not described herein again.

S504: The first communication device sends the channel state information corresponding to the target access points, and correspondingly, the access point receives the channel state information corresponding to the target access points.

Optionally, the first communication device sends a quantity of target access points and/or the threshold.

It should be noted that the state information corresponding to the target access points may be sent to the M access points, or may be sent to the Mₖ target access points, or sent to one of the access points. This is not limited in this embodiment of this application.

It should be understood that the access point in the method 500 may include the second communication device in the method 200, the method 300, or the method 400.

In this embodiment of this application, the communication device may measure and feed back the channel state information based on the threshold. In this process, a quantity of access points for providing a service for the first communication device may be determined, thereby improving communication performance.

It should be understood that the method 300, the method 400, and the method 500 may be used as independent embodiments, or may be combined with each other. This is not limited in this application.

The following embodiment provides a method for determining transmit power of a pilot and transmit power of data. The method may be used as an independent embodiment, or may be combined with another embodiment. This is not limited in this application.

For example, a massive multiple-input multiple-output (MIMO) technology is introduced from a perspective of space, and can support access of a plurality of users without sacrificing a time-frequency resource. In addition, due to a channel hardening feature, this technology may be applicable to electromagnetic propagation environments such as multi-reflection and scattering in a smart factory. Cell-free massive MIMO can improve a signal to interference plus noise ratio of a communication device. However, due to low latency and a future that a data packet in the smart factory is small, data needs to be transmitted in a finite block length (low latency). Currently, a Shannon formula and a related algorithm based on the Shannon formula cannot meet the foregoing transmission requirement. It should be noted that an expression of an achievable rate in the finite block length is a non-convex and non-concave function about a signal to interference plus noise ratio, a block length, and a transmission error probability.

According to an optimization method for combining the transmit power of the pilot and the transmit power of the data in ultra-reliable low-latency uplink cell-free massive MIMO provided in this embodiment of this application, an optimization model that can meet latency and reliability of a plurality of communication devices may be established based on the expression of the achievable rate in the finite block length. Then, an original non-convex and non-concave optimization model is converted by using a theory such as convex optimization, to obtain a fast convergence optimization method.

It should be understood that the optimization method may be performed by the first communication device, or may be performed by the second communication device. This is not limited in this application.

The following uses an example in which the smart factory includes K single-antenna first communication devices and M access points to describe in detail the optimization method for combining the transmit power of the pilot and the transmit power of the data in ultra-reliable low-latency cell-free massive MIMO.

The optimization method may include step 1 to step 6. The following describes in detail each step in the optimization method.

Step 1: A first communication device k selects, based on a large-scale channel ratio, an access point set Mₖ accessed by the first communication device k.

Optionally, a selection criterion of Mₖ is that for any k^{th} first communication device, large-scale information {β_{m,k}}_{m=1, 2, . . . ,M} is arranged in descending order and added to the set Mₖ one by one until

$$\frac{{\sum }_{m ∈ {M}_{k}} {β}_{m , k}}{{\sum }_{m = 1}^{M} {β}_{m , k}} \geq {T}_{h} is true ,$$

where

Tₕ∈(0,1] is a threshold set by a system, and B_{m,k} is a large-scale channel gain from the k^{th} first communication device to an m^{th} access point. It should be understood that a larger threshold indicates a larger quantity of access points of the first communication device k (the k^{th} first communication device).

In this embodiment of this application, the first communication device k sends an orthogonal pilot sequence to an access point in the set Mₖ. A quantity of pilots is K, time used for pilot transmission is K/B_{w} s, where B_{w} is bandwidth occupied by the system.

In this embodiment of this application, the first communication device k may upload B_{w}Rₖ^{req}-bit small-packet data to the access point within time of T=L/B_{w} seconds at a transmission error probability εₖ, so that a weighted sum rate of an entire uplink system is maximized and a maximum energy constraint Eₖ of each first communication device is met, where B_{w} is system bandwidth, L is a total block length, Rₖ^{req} is a minimum rate requirement, and ∀k=1, 2, . . . , K.

Step 2: After receiving the pilot sequence, each access point estimates, by using an MMSE, a channel between a first communication device connected to the access point and the access point, and feeds back channel information to the first communication device.

Optionally, the pilot sequence sent by the k^{th} first communication device is denoted as qₖ, and MMSE channel estimation is used. In this case, a channel estimation value of the m^{th} access point for the k^{th} first communication device is:

$${{g}^{⌢}}_{m , k} = \frac{K {p}_{k}^{p} {β}_{m , k}}{K {p}_{k}^{p} {β}_{m , k} + 1} {{y}^{⌢}}_{m , k}^{p} ,$$

where

B_{m,k} is the large-scale channel gain from the k^{th} first communication device to the m^{th} access point, pₖ^{p} is transmit power of a pilot of the first communication device k,

$${{y}^{⌢}}_{m , k}^{p} = \frac{1}{\sqrt{{Kp}_{k}^{p}}} {Y}_{m}^{p} {q}_{k} ,$$

Yₘ^{p} is a pilot signal matrix received by the m^{th} access point, and ∀m=1, 2, . . . , M.

Step 3: The first communication device performs uplink data transmission.

Optionally, time used for data sending is (L−K)/B_{w} s, and T=L/B_{w} is a total latency requirement for uplink data packet transmission.

Step 4: Derive a rate lower bound of each first communication device under a latency requirement (T) and a high reliability requirement (εₖ).

Optionally, if maximum ratio combining is used for receiving, a decoding vector of the m^{th} access point for uplink data of the k^{th} first communication device is equal to the estimated channel vector ĝ_{m,k}. An average signal to interference plus noise ratio of the first communication device k may be calculated as:

$${{γ}^{⌢}}_{k}^{MRC} = \frac{N {{p}_{k}^{d} ( {\sum }_{m ∈ {M}_{k}} {λ}_{m , k} )}^{2}}{{\sum }_{{k}^{′} = 1}^{K} {\sum }_{m ∈ {M}_{k}} {p}_{{k}^{′}}^{d} {γ}_{m , k} {λ}_{m , {k}^{′}} + {\sum }_{m ∈ {M}_{k}} {λ}_{m , k}} ,$$

where

$${λ}_{m , k} = \frac{{{Kp}_{k}^{p} ( {β}_{m , k} )}^{2}}{{Kp}_{k}^{p} {β}_{m , k} + 1} ,$$

γ_{m,k} is a signal matrix of the first communication device k and the m^{th} access point, and pₖ^{d} and pₖ^{p} are respectively transmit power of data and transmit power of a pilot of the k^{th} first communication device.

A lower bound of an achievable rate of the first communication device k may be represented as:

$${{R}^{⌢}}_{k}^{MRC} = {B}_{w} \cdot {f}_{k} ( \frac{1}{{{r}^{⌢}}_{k}^{MRC}} ) ,$$

where

$${f}_{k} ( \frac{1}{x} ) = \frac{1 - η}{ln 2} [ ln ( 1 + x ) - {α}_{k} V ( x ) ] ,$$

$${α}_{k} = \frac{{Q}^{- 1} ( {ε}_{k} )}{\sqrt{L ( 1 - η )}} ,$$

$$V ( x ) = \sqrt{1 - \frac{1}{{( x + 1 )}^{2}}} ,$$

$$η = K / L ,$$

$$Q ( {ε}_{k} ) = \frac{1}{\sqrt{2 π}} {\int }_{{ε}_{k}}^{∞} {e}^{- {t}^{2} / 2} dt £ ¬ ∀ k ,$$

and εₖ is the transmission error probability of the first communication device k.

Step 5: Combine the transmit power {pₖ^{p},∀k} of the pilot and the transmit power {pₖ^{p},∀k} of the data, and establish an optimization model that aims to maximize a weighted sum rate of the first communication device and meets both the energy limitation Eₖ and the minimum rate requirement Rₖ^{req} of the first communication device, where Eₖ=P̅·B_{w}·T, and P̅ is an average total transmit power limitation of the first communication device.

Optionally, step 5 may include step 5.1 to step 5.3.

Step 5.1: Constraint C1: The first communication device k uploads the B_{w}Rₖ^{req}-bit small-packet data to the access point within the time of L/B_{w} seconds at the transmission error probability εₖ, and a corresponding constraint condition is: \hat{R}ₖ^{MRC}≥Rₖ^{req}, ∀k.

Step 5.2: Constraint C2: Due to a power supply limitation of an uplink first communication device, an energy constraint on the transmit power of the data and the transmit power of the pilot is: Kpₖ^{p}+(L−K)pₖ^{d}≤Eₖ.

Step 5.3: Establish an optimization model for maximizing the weighted sum rate:

$${max}_{\{ {p}_{k}^{p} \} , \{ {p}_{k}^{d} \}} {\sum }_{k = 1}^{K} {w}_{k} {{R}^{⌢}}_{k}^{MRC} \qquad ( P0 )$$

$$s . t . C 1 : {{R}^{⌢}}_{k}^{MRC} \geq {R}_{k}^{req} , ∀ k ,$$

$$C 2 : {Kp}_{k}^{p} + ( L - K ) {p}_{k}^{d} \leq {E}_{k} , ∀ k ,$$

where

wₖ is a weight coefficient of the achievable rate of the first communication device k.

Step 6: Solve the optimization model to obtain the transmit power of the pilot and the transmit power of the data.

Optionally, step 6 may include step 6.1 to step 6.7.

Step 6.1: Introduce an auxiliary variable to simplify an objective function, and further, the foregoing problem (P0) may be equivalent to the following problem (P1):

$${max}_{\{ {p}_{k}^{p} \} , \{ {p}_{k}^{d} \} , \{ {χ}_{k} \}} {\sum }_{k = 1}^{K} {w}_{k} \frac{( 1 - η )}{ln 2} [ ln ( 1 + {χ}_{k} ) - {α}_{k} V ( {χ}_{k} ) ] \qquad ( P1 )$$

$$s . t . {{γ}^{⌢}}_{k}^{MRC} \geq {χ}_{k} , ∀ k ,$$

$${χ}_{k} \geq \frac{1}{{f}_{k}^{- 1} ( \frac{{R}_{k}^{req} ln 2}{1 - η} )} , ∀ k ,$$

$${Kp}_{k}^{p} + ( L - K ) {p}_{k}^{d} \leq {E}_{k} , ∀ k .$$

Step 6.2: Denote a power allocation value of an i^{th} iteration as {pₖ^{p(i)},pₖ^{d(i)},∀k}, and correspondingly, χₖ introduced in the foregoing formula is χₖ⁽ⁱ⁾.

In an i+1ₜₕ iteration, the objective function is approximated, so that an objective function of the optimization problem (P1) can be transformed into:

$${\prod }_{k - 1}^{K} {χ}_{k}^{{\hat{w}}_{k}^{( i )}} ,$$

where

$${{w}^{⌢}}_{k}^{( j )} = {w}_{k} \frac{( 1 - η )}{ln 2} ( {ρ}^{( i )} - {α}_{k} {{ρ}^{⌢}}^{( i )} ) ,$$

$${ρ}^{( i )} = \frac{{χ}_{k}^{( i )}}{\sqrt{{( {χ}_{k}^{( i )} )}^{2} + 2 {χ}_{k}^{( i )}}} - \frac{{x}_{k}^{( i )} \sqrt{{( {χ}_{k}^{( i )} )}^{2} + 2 {χ}_{k}^{( i )}}}{{( 1 + {χ}_{k}^{( i )} )}^{2}} ,$$

$$and$$

$${{ρ}^{⌢}}^{( j )} = \frac{{χ}_{k}^{( i )}}{1 + {χ}_{k}^{( i )}} .$$

Step 6.3: Perform exponential approximation on a first constraint condition of the problem (P1), and the optimization problem (P1) may be transformed into:

$${max}_{\{ {p}_{k}^{p} \} , \{ {p}_{k}^{d} \} , \{ {χ}_{k} \}} {\prod }_{k - 1}^{K} {χ}_{k}^{{{w}^{⌢}}_{k}^{( i )}} , \qquad ( P2 )$$

$$s . t . {Ne}^{2 {c}_{k}^{( i )}} {( {p}_{k}^{p} )}^{2 {a}_{k}^{( i )}} {p}_{k}^{d} \geq {χ}_{k} [ {σ}_{k} ( {\sum }_{{k}^{′} = 1}^{K} {p}_{{k}^{′}} {ξ}_{k , {k}^{′}} + {θ}_{k} ) ] , ∀ k , ,$$

$$where$$

$${χ}_{k} \geq \frac{1}{{f}_{k}^{- 1} ( \frac{{R}_{k}^{req} ln 2}{1 - η} )} , ∀ k ,$$

$${Kp}_{k}^{p} + ( L - K ) {p}_{k}^{d} \leq {E}_{k} , ∀ k ,$$

$${a}_{k}^{( i )} = 1 + \frac{{\sum }_{m ∈ {M}_{k}} [ {( {β}_{m , k} )}^{2} {\sum }_{n \neq m} [ K {β}_{n , k} {p}_{k}^{p ( i )} {\prod }_{i \neq m , n} ( K {β}_{i , k} {p}_{k}^{p ( i )} + 1 ) ] ]}{{\sum }_{m ∈ {M}_{k}} [ {( {β}_{m , k} )}^{2} {\prod }_{n \neq m} ( K {β}_{n , k} {p}_{k}^{p ( i )} + 1 ) ]} ,$$

$${c}_{k}^{( i )} = ln ( {Kp}_{k}^{p ( i )} {\sum }_{m ∈ {M}_{k}} [ {( {β}_{m , k} )}^{2} {\prod }_{n \neq m} ( {Kp}_{k}^{p ( i )} {β}_{n , k} + 1 ) ] ) - {a}_{k}^{( i )} ln ( {p}_{k}^{p ( i )} ) ,$$

$${θ}_{k} = {\sum }_{m ∈ {M}_{k}} [ {Kp}_{k}^{p} {( {β}_{m , k} )}^{2} {\prod }_{n \neq m} ( {Kp}_{k}^{p} {β}_{n , k} + 1 ) ] ,$$

$${σ}_{k} = {\prod }_{m ∈ {M}_{k}} ( {Kp}_{k}^{p} {β}_{m , k} + 1 ) ,$$

$${ξ}_{k , {k}^{′}} = {\prod }_{m ∈ {M}_{k}} [ {Kp}_{k}^{p} {( {β}_{m , k} )}^{2} {β}_{m , {k}^{′}} {\prod }_{n \neq m} ( {Kp}_{k}^{p} {β}_{n , k} + 1 ) ] ,$$

and N represents a quantity of antennas configured on each access point.

Step 6.4: Initialize the iteration time i=1, and an iteration error ζ=0.01.

Step 6.5: Initialize the transmit power of the pilot and the transmit power of the data {pₖ^{p(i)},pₖ^{d(i)},∀k}; calculate the average signal to interference plus noise ratio \hat{γ}ₖ^{MRC}, and denote the average signal to interference plus noise ratio as χₖ⁽⁰⁾; calculate an objective function value of (P0), and denote the objective function value as Obj⁽⁰⁾; and calculate {ŵₖ⁽⁰⁾,cₖ⁽⁰⁾,aₖ⁽⁰⁾,∀k}.

Step 6.6: Give {ŵₖ⁽ⁱ⁻¹⁾,cₖ⁽ⁱ⁻¹⁾,aₖ⁽ⁱ⁻¹⁾,∀k}, solve a geometric optimization problem (P2) by using a convex problem solver (convex, CVX) to obtain {pₖ^{p,(i)},pₖ^{d,(i)},∀k}, which is substituted into the objective function of (P0) to obtain Obj⁽ⁱ⁾.

Step 6.7: If |Obj⁽ⁱ⁾−Obj⁽ⁱ⁻¹⁾|/Obj⁽ⁱ⁾>ζ, update {ŵₖ⁽ⁱ⁻¹⁾,cₖ⁽ⁱ⁻¹⁾,aₖ⁽ⁱ⁻¹⁾,∀k}, i=i+1, and go to step 6.6; otherwise, terminate the algorithm.

It should be understood that specific implementation processes shown in the foregoing steps may be implemented in another manner. This is not limited in this application.

The following describes in detail an application effect of the foregoing embodiment with reference to a simulation result.

1. A simulation parameter is set. It is assumed that M access points are evenly distributed in an area in a constellation mapping manner, and locations of K first communication devices are randomly distributed. A path loss model uses a three-segment model. Details are as follows:

$${PL}_{m , k} ( dB ) = \{ \begin{matrix}- L - 35 {log}_{10} ( {d}_{m , k} ) , & {d}_{m , k} > {d}_{1} \\ - L - 15 {log}_{10} ( {d}_{1} ) - 20 {log}_{10} ( {d}_{m , k} ) , & {d}_{1} \geq {d}_{m , k} > {d}_{0} \\ - L - 15 {log}_{10} ( {d}_{1} ) - 20 {log}_{10} ( {d}_{0} ) , & {d}_{0} \geq {d}_{m , k}\end{matrix} ,$$

where

$$L = 46.3 + 33.9 {log}_{10} ( f ) - 13.82 {log}_{10} ( {h}_{AP} ) - ( 1.1 {log}_{10} ( f ) - 0.7 ) {h}_{u} + ( 1.56 {log}_{10} ( f ) - 0 \text{.8} ) ,$$

d_{m,k} is a distance between the k^{th} first communication device and the m^{th} access point, f is a carrier frequency, and h_{AP} and hᵤ are respectively an access point height and a user height. Noise power (Pₙ) is related to bandwidth: Pᵢ=B_{w}×1.381×10⁻²³×290×10^{0.9}.

For example, the simulation parameter is shown in Table 9.

TABLE 9

| Parameter | Value | Parameter | Value |
|---|---|---|---|
| f/MHz | 2100 | K | 10 |
| d₀/meter (m) | 10 | d₁/m | 50 |
| h_{AP}/m | 15 | hᵤ/m | 1.6 |
| R^{req}/bit (bit)/second | 0.5 | | 10⁻⁷ |
| (s)/MHz | | | |
| B_{w}/MHz | 10 | T/millisecond | 0.1 |
| | | (ms) | |
| L | B_{w}T | Energy (Eₖ) | P̅B_{w}T (P̅ = |
| | | | 100 mW by default) |

2: The simulation result is as follows:

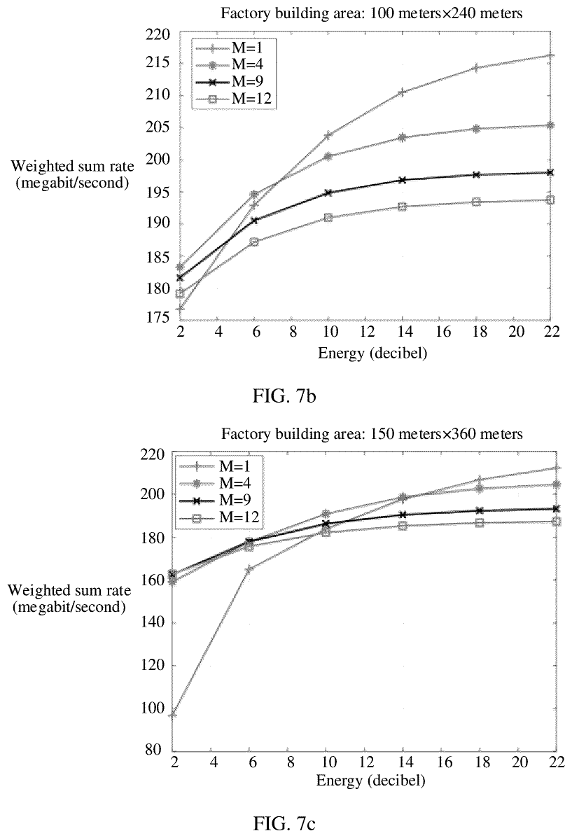

FIG. 6a to FIG. 6d are diagrams in which weighted sum rates vary with an access point threshold in different factory building areas according to embodiments of this application. FIG. 6a shows that when a factory building area is 50 meters×120 meters, a weighted sum rate of centralized massive MIMO (where M=1) remains unchanged as an access point threshold increases, and a weighted sum rate of cell-free massive MIMO (where M=4, M=9, or M=12) increases as the access point threshold increases. FIG. 6b shows that when a factory building area is 100 meters×240 meters, a weighted sum rate of centralized massive MIMO (where M=1) remains unchanged as an access point threshold increases, and a weighted sum rate of cell-free massive MIMO (where M=4, M=9, or M=12) increases as the access point threshold increases. FIG. 6c shows that when a factory building area is 150 meters×360 meters, a weighted sum rate of centralized massive MIMO (where M=1) remains unchanged as an access point threshold increases, and a weighted sum rate of cell-free massive MIMO (where M=4, M=9, or M=12) increases as the access point threshold increases. FIG. 6d shows that when a factory building area is 200 meters×480 meters, a weighted sum rate of centralized massive MIMO (where M=1) remains unchanged as an access point threshold increases, and a weighted sum rate of cell-free massive MIMO (where M=4, M=9, or M=12) increases as the access point threshold increases.

It can be learned from FIG. 6a to FIG. 6d that, based on the parameter setting in Table 1 (where in this case, Eₖ=20 dB), when the factory building area is large (200 meters×480 meters), M=4, and four access points all serve a first communication device, a distributed antenna may obtain a same weighted sum rate effect as a centralized antenna. In another case, centralized massive MIMO has better performance. M in this embodiment of this application is a quantity of access points.

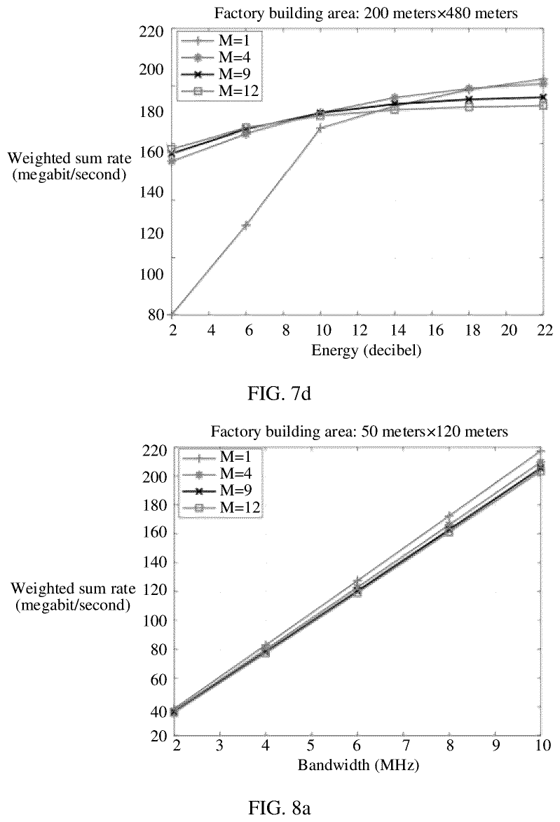

FIG. 7a to FIG. 7d are diagrams in which weighted sum rates vary with energy in different factory building areas according to embodiments of this application. FIG. 7a shows that when a factory building area is 50 meters×120 meters, both a weighted sum rate of centralized massive MIMO (where M=1) and a weighted sum rate of cell-free massive MIMO (where M=4, M=9, or M=12) increase as an access point threshold increases, but for a first communication device under different energy constraints, performance (the weighted sum rate) of centralized massive MIMO is always better than that of cell-free massive MIMO. FIG. 7b shows that when a factory building area is 100 meters×240 meters, both a weighted sum rate of centralized massive MIMO (where M=1) and a weighted sum rate of cell-free massive MIMO (where M=4, M=9, or M=12) increase as an access point threshold increases, but for a first communication device under a low energy constraint (Eₖ<6 dB), when M=4, performance (the weighted sum rate) of cell-free massive MIMO is better than that of centralized massive MIMO. FIG. 7c shows that when a factory building area is 150 meters×360 meters, both a weighted sum rate of centralized massive MIMO (where M=1) and a weighted sum rate of cell-free massive MIMO (where M=4, M=9, or M=12) increase as an access point threshold increases, but a performance difference of three types of cell-free massive MIMO (where M=4, M=9, and M=12) decreases, and when E, <14 dB, performance of centralized massive MIMO is worse than that of other cell-free massive MIMO. FIG. 7d shows that when a factory building area is 200 meters×480 meters, both a weighted sum rate of centralized massive MIMO (where M=1) and a weighted sum rate of cell-free massive MIMO (where M=4, M=9, or M=12) increase as an access point threshold increases, but a performance difference of three types of cell-free massive MIMO (where M=4, M=9, and M=12) further decreases compared with the performance difference when the factory building area is 150 meters×360 meters, and when E, >22 dB, performance of centralized massive MIMO is slightly better than that of cell-free massive MIMO when M=4. Access points are placed in a constellation manner.

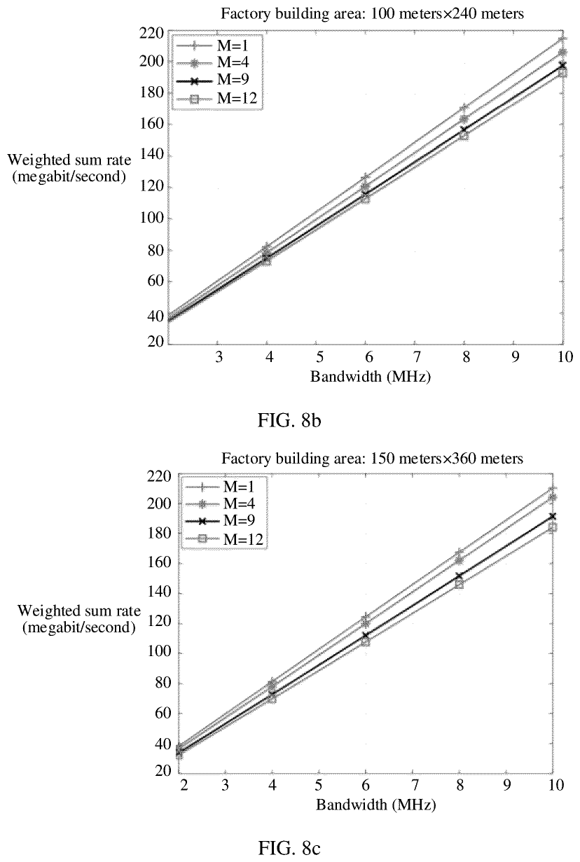

FIG. 8a to FIG. 8d are diagrams in which weighted sum rates vary with bandwidth in different factory building areas according to embodiments of this application. FIG. 8a shows that when a factory building area is 50 meters×120 meters, a weighted sum rate of centralized massive MIMO (where M=1) and a weighted sum rate of cell-free massive MIMO (where M=4, M=9, or M=12) increase as bandwidth increases, but the increase of the weighted sum rate of centralized massive MIMO (where M=1) is the fastest. FIG. 8b shows that when a factory building area is 100 meters×240 meters, a weighted sum rate of centralized massive MIMO (where M=1) and a weighted sum rate of cell-free massive MIMO (where M=4, M=9, or M=12) increase as bandwidth increases, but the increase of the weighted sum rate of centralized massive MIMO (where M=1) is the fastest. FIG. 8c shows that when a factory building area is 150 meters×360 meters, a weighted sum rate of centralized massive MIMO (where M=1) and a weighted sum rate of cell-free massive MIMO (where M=4, M=9, or M=12) increase as bandwidth increases, but the increase of the weighted sum rate of centralized massive MIMO (where M=1) is the fastest. FIG. 8d shows that when a factory building area is 200 meters×480 meters, a weighted sum rate of centralized massive MIMO (where M=1) and a weighted sum rate of cell-free massive MIMO (where M=4, M=9, or M=12) increase as bandwidth increases, and an increase speed of the weighted sum rate of centralized massive MIMO (where M=1) is basically the same as an increase speed of the weighted sum rate of cell-free massive MIMO (where M=4), and is greater than an increase speed of the weighted sum rate of cell-free massive MIMO (where M=9 or M=12).

It can be learned from FIG. 8a to FIG. 8d that, based on the parameter setting in Table 1 (where in this case, B_{w} varies, and a value of Eₖ and L increase as the bandwidth increases), the weighted sum rate increases as the bandwidth increases. In addition, weighted sum rate performance decreases as the factory building area increases, but the decrease is not significant.

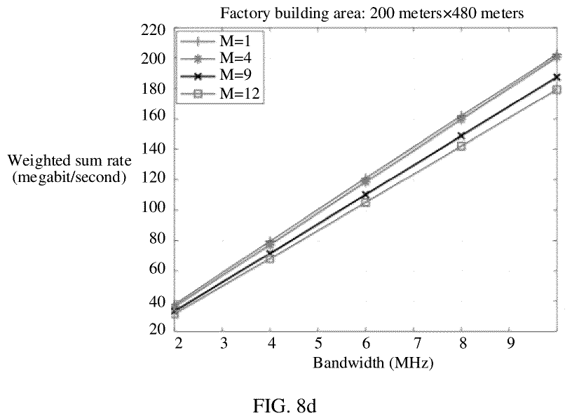

FIG. 9 is a diagram in which weighted sum rates vary with energy in three different solutions according to an embodiment of this application. FIG. 9 shows a difference of weighted sum rate performance varying with energy in three different solutions of determining transmit power of a pilot by using fixed pilot power, combined transmit power of the pilot and data, and a conventional method (based on a conventional Shannon formula) when a factory building area is 1000 meters×1000 meters and M=4. As shown in FIG. 9, in the three manners, the weighted sum rate increases as the energy increases. However, under the same energy, the solution that combines the transmit power of the pilot and the transmit power of the data corresponds to a largest weighted sum rate, in other words, the solution can achieve excellent performance. In addition, under an ultra-low latency requirement, power allocation is performed based on an achievable rate in an infinite block length in the conventional Shannon formula, and a weighted sum rate value of a system is low.

In conclusion, in this application, the optimization method can ensure that the first communication device transmits small-packet data within specified time with specific reliability. In addition, a cell-free massive MIMO technology is used, so that data transmission of a plurality of first communication devices can be simultaneously supported without sacrificing a time-frequency resource, and a minimum transmission rate of each first communication device can be ensured.

It should be understood that sequence numbers of the foregoing processes do not mean execution sequences. The execution sequences of the processes should be determined based on functions and internal logic of the processes, and should not be construed as any limitation on implementation processes of embodiments of this application.

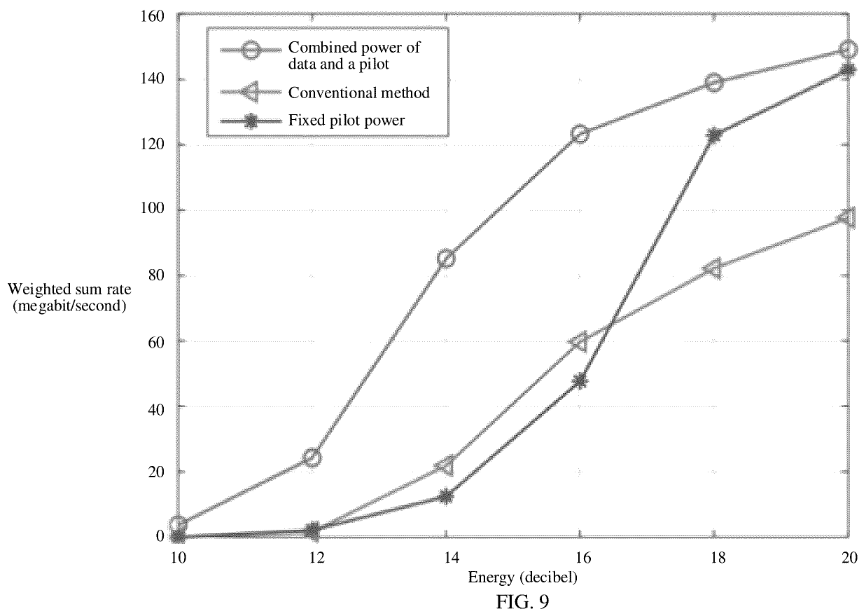

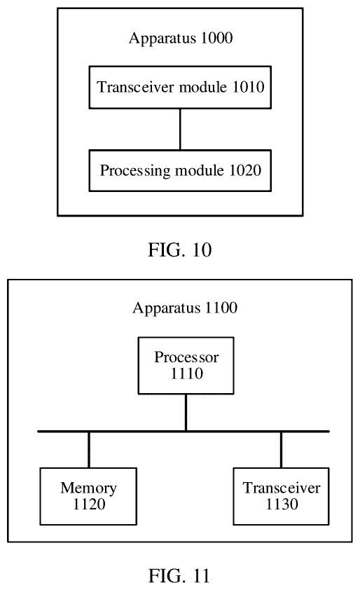

The foregoing describes in detail the communication method in embodiments of this application with reference to FIG. 2 to FIG. 4. The following describes in detail a communication apparatus in embodiments of this application with reference to FIG. 10 and FIG. 11.

FIG. 10 shows a communication apparatus 1000 according to an embodiment of this application. As shown in FIG. 10, the communication apparatus 1000 includes a transceiver module 1010 and a processing module 1020.

In a possible implementation, the communication apparatus 1000 is the foregoing first communication device (a terminal or a network device) or a chip of the first communication device.

The transceiver module 1010 is configured to: receive first indication information, where the first indication information indicates a power parameter, and the power parameter is related to transmit power of a pilot and transmit power of data; and receive second indication information, where the second indication information indicates a pilot length and a data length, the pilot length is a time length for carrying the pilot, and the data length is a time length for carrying the data. The processing module 1020 is configured to perform communication based on the first indication information and the second indication information.

Optionally, the power parameter includes at least one of the following: the transmit power of the pilot, the transmit power of the data, a ratio of the transmit power of the pilot to the transmit power of the data, and a difference between the transmit power of the pilot and the transmit power of the data.

Optionally, the first indication information is determined based on a capability of the first communication device, and the capability of the first communication device includes at least one of the following: a receiver capability, an algorithm capability, and a complexity processing capability.

Optionally, one or more of a value range of the transmit power of the pilot, a value range of the transmit power of the data, a value range of the ratio of the transmit power of the pilot to the transmit power of the data, and a value range of the difference between the transmit power of the pilot and the transmit power of the data have a correspondence with the capability of the first communication device, and are predefined or preconfigured.

Optionally, the second indication information includes at least one of the following: a quantity of code division multiplexing CDM groups of the pilot, a quantity of first communication devices multiplexing a same resource, a subcarrier spacing of the pilot, a quantity of time units of the pilot, duration of the pilot, a subcarrier spacing of the data, a quantity of time units of the data, duration of the data, a ratio of the pilot length to the data length, and a total length of the pilot length and the data length. The quantity of CDM groups of the pilot has a correspondence with the pilot length, and the quantity of first communication devices multiplexing a same resource has a correspondence with the pilot length.

Optionally, the processing module 1020 is further configured to: determine, based on channel measurement on M access points, channel states corresponding to the M access points; and determine, based on a threshold and the channel states, a quantity Mₖ of target access points fed back by the first communication device and channel state information corresponding to the target access points, where a sum of the channel state information of the Mₖ target access points and a sum of channel state information of the M access points are greater than or equal to the threshold, and M and Mₖ are positive integers.

Optionally, the threshold has a correspondence with a first parameter, and the first parameter includes at least one of the following: a scenario, a quantity of access points, and the capability of the first communication device.

In an optional example, a person skilled in the art may understand that the communication apparatus 1000 may be specifically the first communication device in the foregoing embodiments. The communication apparatus 1000 may be configured to perform procedures and/or steps corresponding to the first communication device in the method 200. To avoid repetition, details are not described herein again.

In another possible implementation, the communication apparatus 1000 is a second communication device (a terminal or a network device) or a chip of a second communication device.

The transceiver module 1010 is configured to: send first indication information, where the first indication information indicates a power parameter, and the power parameter is related to transmit power of a pilot and transmit power of data; and send second indication information, where the second indication information indicates a pilot length and a data length, the pilot length is a time length for carrying the pilot, and the data length is a time length for carrying the data. The processing module 1020 is configured to perform communication based on the first indication information and the second indication information.

Optionally, the power parameter includes at least one of the following: the transmit power of the pilot, the transmit power of the data, a ratio of the transmit power of the pilot to the transmit power of the data, and a difference between the transmit power of the pilot and the transmit power of the data.

Optionally, the first indication information is determined based on a capability of the first communication device, and the capability of the first communication device includes at least one of the following: a receiver capability, an algorithm capability, and a complexity processing capability.

Optionally, one or more of a value range of the transmit power of the pilot, a value range of the transmit power of the data, a value range of the ratio of the transmit power of the pilot to the transmit power of the data, and a value range of the difference between the transmit power of the pilot and the transmit power of the data have a correspondence with the capability of the first communication device, and are predefined or preconfigured.

Optionally, the second indication information includes at least one of the following: a quantity of CDM groups of the pilot, a quantity of first communication devices multiplexing a same resource, a subcarrier spacing of the pilot, a quantity of time units of the pilot, duration of the pilot, a subcarrier spacing of the data, a quantity of time units of the data, duration of the data, a ratio of the pilot length to the data length, and a total length of the pilot length and the data length. The quantity of CDM groups of the pilot has a correspondence with the pilot length, and the quantity of first communication devices multiplexing a same resource has a correspondence with the pilot length.

In an optional example, a person skilled in the art may understand that the communication apparatus 1000 may be specifically the second communication device in the foregoing embodiments. The communication apparatus 1000 may be configured to perform procedures and/or steps corresponding to the second communication device in the method 200. To avoid repetition, details are not described herein again.

It should be understood that the communication apparatus 1000 herein is embodied in a form of a functional module. The term “module” herein may be an application-specific integrated circuit (application-specific integrated circuit, ASIC), an electronic circuit, a processor (for example, a shared processor, a dedicated processor, or a group processor) configured to execute one or more software or firmware programs, a memory, a combinational logic circuit, and/or another suitable component that supports the described functions. In an optional example, a person skilled in the art may understand that the communication apparatus 1000 may be specifically the first communication device or the second communication device in the foregoing embodiments, or a function of the first communication device or the second communication device in the foregoing embodiments may be integrated into the communication apparatus 1000. The communication apparatus 1000 may be configured to perform procedures and/or steps corresponding to the first communication device or the second communication device in the foregoing method embodiments. To avoid repetition, details are not described herein again.

The communication apparatus 1000 has a function of implementing corresponding steps performed by a data processing device in the foregoing methods. The function may be implemented by hardware, or may be implemented by hardware by executing corresponding software. The hardware or the software includes one or more modules corresponding to the function. For example, the transceiver module 1010 may be a communication interface, for example, a transceiver interface.

FIG. 11 shows another communication apparatus 1100 according to an embodiment of this application. The communication apparatus 1100 includes a processor 1110, a memory 1120, and a transceiver 1130. The processor 1110, the memory 1120, and the transceiver 1130 are connected through an internal connection path. The memory 1120 is configured to store instructions. The processor 1110 is configured to execute the instructions stored in the memory 1120, so that the communication apparatus 1100 can perform the communication method provided in the foregoing method embodiments.

It should be understood that a function of the communication apparatus 1000 in the foregoing embodiments may be integrated into the communication apparatus 1100. The communication apparatus 1100 may be configured to perform steps and/or procedures corresponding to the first communication device in the foregoing method embodiments, or the communication apparatus 1100 may be further configured to perform steps and/or procedures corresponding to the second communication device in the foregoing method embodiments. Optionally, the memory 1120 may include a read-only memory and a random access memory, and provide the instructions and data to the processor. A part of the memory may further include a non-volatile random access memory. For example, the memory may further store information of a device type. The processor 1110 may be configured to execute the instructions stored in the memory. When the processor executes the instructions, the processor 1110 may perform the steps and/or procedures corresponding to the first communication device in the foregoing method embodiments, or the processor 1110 may perform the steps and/or procedures corresponding to the second communication device in the foregoing method embodiments.

It should be understood that in this embodiment of this application, the processor 1110 may be a central processing unit (CPU). The processor 1110 may alternatively be another general-purpose processor, a digital signal processor (DSP), an ASIC, a field programmable gate array (FPGA) or another programmable logic device, a discrete gate or transistor logic device, a discrete hardware component, or the like. The processor 1110 may be a microprocessor or the processor 1110 may be any conventional processor or the like.

In an implementation process, steps in the method 200 can be implemented by using a hardware integrated logical circuit in the processor, or by using instructions in a form of software. The steps of the method disclosed with reference to embodiments of this application may be directly performed by a hardware processor, or may be performed by using a combination of hardware in the processor and a software module. The software module may be located in a mature storage medium in the art, such as a random access memory, a flash memory, a read-only memory, a programmable read-only memory, an electrically erasable programmable memory, or a register. The storage medium is located in the memory. The processor executes the instructions in the memory and completes the steps in the foregoing methods in combination with the hardware of the processor. To avoid repetition, details are not described herein again.

This application further provides a computer-readable medium. The computer-readable medium stores a computer program. When the computer program is executed by a computer, functions of any one of the foregoing method embodiments are implemented.

This application further provides a computer program product. When the computer program product is executed by a computer, functions of any one of the foregoing method embodiments are implemented.

A person of ordinary skill in the art may be aware that, in combination with the examples described in embodiments disclosed in this specification, units and algorithm steps can be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and module, refer to a corresponding process in the foregoing method embodiments. Details are not described herein again.

In some embodiments provided in this application, it should be understood that the disclosed system, apparatus and method may be implemented in another manner. For example, the described apparatus embodiments are merely examples. For example, division into the units is merely logical function division and may be other division during actual implementation. For example, a plurality of units or components may be combined or integrated into another system, or some features may be ignored or not performed. In addition, the displayed or discussed mutual couplings, direct couplings, or communication connections may be implemented through some interfaces. The indirect couplings or communication connections between the apparatuses or units may be implemented in electronic, mechanical, or another form.

The units described as separate parts may or may not be physically separate, and parts displayed as units may or may not be physical units, that is, may be located in one position, or may be distributed on a plurality of network units. Some or all of the units may be selected based on actual requirements to achieve the objectives of the solutions of embodiments.

In addition, function units in embodiments of this application may be integrated into one processing unit, each of the units may exist alone physically, or two or more units are integrated into one unit.

When the functions are implemented in a form of a software functional unit and sold or used as an independent product, the functions may be stored in a computer-readable storage medium. Based on such an understanding, the technical solutions of this application essentially, or the part contributing to some embodiments, or some of the technical solutions may be implemented in a form of a software product. The computer software product is stored in a storage medium, and includes several instructions for instructing a computer device (which may be a personal computer, a server, or a network device) to perform all or some of the steps of the methods described in embodiments of this application. The foregoing storage medium includes any medium that can store program code, such as a USB flash drive, a removable hard disk, a read-only memory (ROM), a random access memory (RAM), a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A communication method, applied to a first communication device, wherein the method comprises:
receiving first indication information, wherein the first indication information indicates a power parameter, and the power parameter is related to transmit power of a pilot and transmit power of data;
receiving second indication information, wherein the second indication information indicates a pilot length and a data length, the pilot length is a time length for carrying the pilot, and the data length is a time length for carrying the data; and
performing communication based on the first indication information and the second indication information.

2. The method according to claim 1, wherein the power parameter comprises: the transmit power of the pilot and the transmit power of the data, or a ratio of the transmit power of the pilot to the transmit power of the data.

3. The method according to claim 1, wherein the power parameter comprises at least one of the following:
the transmit power of the pilot, the transmit power of the data, a ratio of the transmit power of the pilot to the transmit power of the data, and a difference between the transmit power of the pilot and the transmit power of the data.

4. The method according to claim 3, wherein the first indication information is determined based on a capability of the first communication device, and the capability of the first communication device comprises at least one of the following: a receiver capability, an algorithm capability, and a complexity processing capability.

5. The method according to claim 3, wherein one or more of a value range of the transmit power of the pilot, a value range of the transmit power of the data, a value range of the ratio of the transmit power of the pilot to the transmit power of the data, and a value range of the difference between the transmit power of the pilot and the transmit power of the data have a correspondence with the capability of the first communication device, and are predefined or preconfigured.

6. The method according to claim 1, wherein the second indication information comprises at least one of the following:
a quantity of code division multiplexing CDM groups of the pilot, a quantity of first communication devices multiplexing a same resource, a subcarrier spacing of the pilot, a quantity of time units of the pilot, duration of the pilot, a subcarrier spacing of the data, a quantity of time units of the data, duration of the data, a ratio of the pilot length to the data length, and a total length of the pilot length and the data length, wherein
the quantity of CDM groups of the pilot has a correspondence with the pilot length, and the quantity of first communication devices multiplexing a same resource has a correspondence with the pilot length.

7. The method according to claim 6, wherein the correspondence between the quantity of CDM groups of the pilot and the pilot length is determined based on a first mapping relationship, and the first mapping relationship indicates the correspondence between the quantity of CDM groups of the pilot and the pilot length; the correspondence between the quantity of first communication devices multiplexing a same resource and the pilot length is determined based on a second mapping relationship, and the second mapping relationship indicates the correspondence between the quantity of first communication devices multiplexing a same resource and the pilot length; and the first mapping relationship and/or the second mapping relationship are/is predefined or preconfigured.

8. The method according to claim 1, wherein the second indication information comprises a subcarrier spacing of the pilot, a quantity of time units of the pilot, a subcarrier spacing of the data, and a quantity of time units of the data.

9. The method according to claim 8, wherein the pilot length comprises the subcarrier spacing of the pilot, the quantity of time units of the pilot, or duration of the pilot; and the data length comprises the subcarrier spacing of the data, the quantity of time units of the data, or duration of the data.

10. The method according to claim 1, wherein the method further comprises:
determining, based on channel measurement on M access points, channel states corresponding to the M access points; and
determining, based on a threshold and the channel states, a quantity Mₖ of target access points fed back by the first communication device and channel state information corresponding to the target access points, wherein a sum of the channel state information of the Mₖ target access points and a sum of channel state information of the M access points are greater than or equal to the threshold, and M and Mₖ are positive integers.

11. The method according to claim 10, wherein the threshold has a correspondence with a first parameter, and the first parameter comprises at least one of the following: a scenario, a quantity of access points, and the capability of the first communication device.

12. A communication method, applied to a second communication device, wherein the method comprises:
sending first indication information, wherein the first indication information indicates a power parameter, and the power parameter is related to transmit power of a pilot and transmit power of data;
sending second indication information, wherein the second indication information indicates a pilot length and a data length, the pilot length is a time length for carrying the pilot, and the data length is a time length for carrying the data; and
performing communication based on the first indication information and the second indication information.

13. The method according to claim 12, wherein the power parameter comprises: the transmit power of the pilot and the transmit power of the data, or a ratio of the transmit power of the pilot to the transmit power.

14. The method according to claim 12, wherein the power parameter comprises at least one of the following:
the transmit power of the pilot, the transmit power of the data, a ratio of the transmit power of the pilot to the transmit power of the data, and a difference between the transmit power of the pilot and the transmit power of the data.

15. The method according to claim 14, wherein the first indication information is determined based on a capability of a first communication device, and the capability of the first communication device comprises at least one of the following: a receiver capability, an algorithm capability, and a complexity processing capability.

16. The method according to claim 15, wherein one or more of a value range of the transmit power of the pilot, a value range of the transmit power of the data, a value range of the ratio of the transmit power of the pilot to the transmit power of the data, and a value range of the difference between the transmit power of the pilot and the transmit power of the data have a correspondence with the capability of the first communication device, and are predefined or preconfigured.

17. The method according to claim 12, wherein the second indication information comprises at least one of the following:
a quantity of code division multiplexing CDM groups of the pilot, a quantity of first communication devices multiplexing a same resource, a subcarrier spacing of the pilot, a quantity of time units of the pilot, duration of the pilot, a subcarrier spacing of the data, a quantity of time units of the data, duration of the data, a ratio of the pilot length to the data length, and a total length of the pilot length and the data length, wherein
the quantity of CDM groups of the pilot has a correspondence with the pilot length, and the quantity of first communication devices multiplexing a same resource has a correspondence with the pilot length.

18. The method according to claim 17, wherein the correspondence between the quantity of code division multiplexing CDM groups of the pilot and the pilot length is determined based on a first mapping relationship, and the first mapping relationship indicates the correspondence between the quantity of CDM groups of the pilot and the pilot length; the correspondence between the quantity of first communication devices multiplexing a same resource and the pilot length is determined based on a second mapping relationship, and the second mapping relationship indicates the correspondence between the quantity of first communication devices multiplexing a same resource and the pilot length; and the first mapping relationship and/or the second mapping relationship are/is predefined or preconfigured.

19. The method according to claim 12, wherein the second indication information comprises a subcarrier spacing of the pilot, a quantity of time units of the pilot, a subcarrier spacing of the data, and a quantity of time units of the data.

20. The method according to claim 19, wherein the pilot length comprises the subcarrier spacing of the pilot, the quantity of time units of the pilot, or duration of the pilot; and the data length comprises the subcarrier spacing of the data, the quantity of time units of the data, or duration of the data.
